(19) United States
(12) Patent Application Publication
(10) Pub. No.: US 2015/0339460 A1
(43) Pub. Date: Nov. 26, 2015

(54) METHODS AND SYSTEMS FOR PROVIDING SCAN-TRIGGERED HEALTH CARE INSTRUCTION AND REMINDER SERVICES

(71) Applicant: Flashback Survey, Inc., Chapel Hill, NC (US)

(72) Inventor: Peter Joseph Marsico, Chapel Hill, NC (US)

(21) Appl. No.: 14/719,292

(22) Filed: May 21, 2015

Related U.S. Application Data
(60) Provisional application No. 62/001,673, filed on May 22, 2014.
(60) Provisional application No. 62/011,750, filed on Jun. 13, 2014.
(60) Provisional application No. 62/018,832, filed on Jun. 30, 2014.
(60) Provisional application No. 62/021,143, filed on Jul. 5, 2014.
(60) Provisional application No. 62/032,596, filed on Aug. 3, 2014.
(60) Provisional application No. 62/050,172, filed on Sep. 14, 2014.
(60) Provisional application No. 62/051,980, filed on Sep. 18, 2014.
(60) Provisional application No. 62/068,785, filed on Oct. 27, 2014.

(51) Int. Cl. G06F 19/00

(52) U.S. Cl. CPC G06F 19/3481

(57) ABSTRACT

Disclosed are methods, systems and computer program products for facilitating scan-triggered healthcare instruction and reminder services to a user using a scanable information encoded graphic image, such as a bar code or a quick response (QR) code. In one embodiment, a mobile communication device such as a smartphone, tablet computer or other mobile computer is adapted to include a scan client module for scanning and communicating scan-triggered service code information to a scan-triggered application server. The scan-enabled client module communicates extracted healthcare instruction set identifier information to an associated scan-triggered healthcare instruction and reminder service server application, which is adapted to resolve and deliver chronologically ordered healthcare instruction step information to the scanning user, as well as providing reminder notification services and collecting instruction step compliance data.

### PRIORITY CLAIM

This application claims the benefit of U.S. Provisional Patent Application Ser. No. 62/001,673, filed on May 22, 2014, U.S. Provisional Patent Application Ser. No. 62/011,750, filed on Jun. 13, 2014, U.S. Provisional Patent Application Ser. No. 62/018,832, filed on Jun. 30, 2014, U.S. Provisional Patent Application Ser. No. 62/021,143, filed on Jul. 5, 2014, U.S. Provisional Patent Application Ser. No. 62/032,596, filed on Aug. 3, 2014, U.S. Provisional Patent Application Ser. No. 62/050,172 filed on Sep. 14, 2014, U.S. Provisional Patent Application Ser. No. 62/051,980, filed on Sep. 18, 2014, and U.S. Provisional Patent Application Ser. No. 62/068,785 filed on Oct. 27, 2014; the disclosures of which are incorporated herein by reference in their entireties.

### TECHNICAL FIELD

The subject matter described herein relates to methods and systems for using a scanable service code to provide healthcare instruction and reminder services to a scanning user.

### BACKGROUND

Healthcare service providers and the providers of healthcare related products are faced with the increasingly difficult task of providing a high quality consumer experience that is capable of reaching and engaging the widest possible range of end user in a way that is economically and administratively feasible. Quick response (QR) codes and other types of scanable codes can be scanned by users of mobile communication devices, such as smartphones, tablet computers, notebook computers, and wearable computing devices, such as computer-integrated eyeglasses. Services can be easily and rapidly invoked via the scanning of such scanable codes. What is needed is a system and method to enable a scanning user to quickly and easily access healthcare instruction step information, receive instruction step reminders, signal compliance with these instruction steps, and receive associated instruction step compliance incentives.

### SUMMARY

According to one aspect, the subject matter described herein includes systems and methods for facilitating the association of a healthcare patient instruction set or template with a scanable service scan code. Exemplary healthcare patient instruction sets may include pre- and post-surgical or diagnostic procedure instructions, physical therapy rehabilitation instructions, medication dosing and dose administration schedule instructions, wound management instructions and skin care instructions. In one embodiment, a healthcare instruction set or template may include relative date/time offset information for each instruction step (e.g., stop drinking fluids 2 hours prior to surgery, re-apply sunscreen 90 minutes after initial/previous application, etc.). The associated scan code is scanned (e.g., by a patient user, patient guardian, etc.) and reference date/time information (e.g., surgery date/time information) is provided. Reference date/time may be manual input by the scanning user, or may be implied from/taken as the date/time associated with the scanning of the scanable healthcare instruction step service code. The reference date/time information is bound to the patient user and is used to resolve the relative date/time offsets in the associated healthcare instruction set or template, such that a chronologically ordered set of healthcare instruction steps is presented to the patient. A patient user may signal compliance for each instruction step, and the compliance information is logged. Compliance incentive rewards may be offered and distributed to a scanning patient user. A compliance guardian may be associated with a patient's healthcare instruction set, such that the compliance guardian is notified (e.g., via text message, email, etc.) if the patient user does not signal compliance with a required healthcare instruction step. Electronic calendaring event invitations/reminders may be associated with and generated for healthcare instruction steps and transmitted to the patient user. Text or instant message reminder notification messages may be generated for healthcare instruction steps and transmitted to the patient user. In cases where an instruction step is optional, for example, an instruction step that involves the administration of an over the counter (OTC) pain medication, a patient user may be presented with an indicator of the earliest recommended date/time that another dose of the associated OTC medication can be taken, or sent a reminder (e.g., text message) at the earliest recommended date/time that another dose of the associated OTC medication can be taken. In the case of a skin care/sunscreen deployment, an instruction step that involves the re-application of a sunscreen agent, a user may be presented with an indicator of the latest recommended date/time that an associated skin healthcare/sunscreen product should be re-applied, or sent a reminder (e.g., text message) at the latest recommended date/time that re-application of a skin healthcare protection product should occur.

The subject matter described herein for providing scan-triggered services may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a non-transitory computer readable medium having stored thereon computer executable instructions that when executed by the processor of a computer perform steps. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a block diagram which illustrates a mobile communication device (e.g., smartphone) that includes a scanable code reader module, such as a quick response (QR) code scanner module and exemplary scan-enabled client module;

FIG. 2 is a block diagram which illustrates an application server that includes an exemplary server application module, which is adapted to facilitate the creation and processing of a scanable healthcare instruction and reminder service code and associated compliance incentive rewards;

FIG. 3 is a process flow diagram which illustrates exemplary provisioning of a scan-triggered application services platform that is adapted to provide scan-triggered medical procedure-related healthcare instruction and reminder services to scanning users;

FIGS. 4A-4B illustrate an exemplary process and information flow diagram, which illustrates initial user scan processing and information flow associated with a medical procedure healthcare instruction and reminder service embodiment of the present subject matter;

FIG. 5 illustrates an exemplary process and information flow diagram, which illustrates subsequent user scan processing and information flow associated with a medical procedure healthcare instruction and reminder service embodiment of the present subject matter;

FIG. 6 illustrates a first exemplary embodiment of the present subject matter that includes the granting, distribution and redemption of an online game asset credit as a compliance incentive reward;

FIG. 7 illustrates a second exemplary embodiment of the present subject matter that includes the granting, distribution and redemption of an online game asset credit as a compliance incentive reward;

FIGS. 8A-8B illustrate a first exemplary process and information flow diagram, which illustrates initial user scan processing and information flow associated with a medication dosing and scheduling healthcare instruction and reminder service embodiment of the present subject matter;

FIG. 9 illustrates a second exemplary process and information flow diagram, which illustrates initial user scan processing and information flow associated with a medication dosing and scheduling healthcare instruction and reminder service embodiment of the present subject matter;

FIGS. 10A-10B illustrate an exemplary process and information flow diagram, which illustrates initial user scan processing and information flow associated with a skin care healthcare instruction and reminder service embodiment of the present subject matter;

FIGS. 11A-11B illustrate a first exemplary process and information flow diagram, which illustrates initial user scan processing and information flow associated with a wound care healthcare instruction and reminder service embodiment of the present subject matter;

FIGS. 12A-12B illustrate a second exemplary process and information flow diagram, which illustrates initial user scan processing and information flow associated with a wound care healthcare instruction and reminder service embodiment of the present subject matter;

FIGS. 13-15 illustrate exemplary user and healthcare instruction and reminder service provisioning data associated with medical procedure-related embodiments of the present healthcare instruction and reminder service subject matter;

FIGS. 16-17 illustrate exemplary user and healthcare instruction and reminder service provisioning data associated with medication dosing and scheduling-related embodiments of the present healthcare instruction and reminder service subject matter;

FIG. 18 illustrates exemplary user and healthcare instruction and reminder service provisioning data associated with skin care-related embodiments of the present healthcare instruction and reminder service subject matter; and

FIGS. 19-20 illustrate exemplary user and healthcare instruction and reminder service provisioning data associated with wound care-related embodiments of the present healthcare instruction and reminder service subject matter.

### DETAILED DESCRIPTION OF THE INVENTION

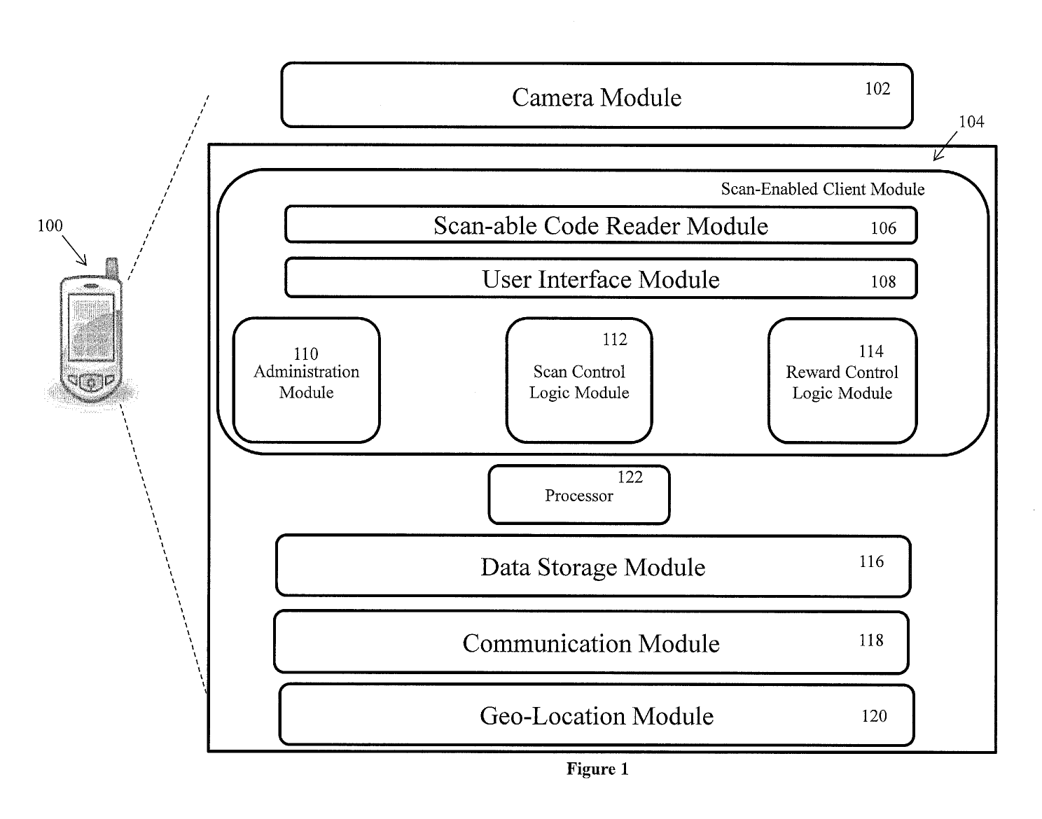

Disclosed are systems and methods for using a scanable code, such as quick response (QR) code, a near field communication (NFC) code, radio frequency identification (RFID) code, or similar optical, magnetic or electrical scanable codes, to provide healthcare related services to a user who scans an associated scan-triggered healthcare service scan code. In a one embodiment, a scan code-based services system of the subject matter described herein includes a scan-enabled client module, which may be implemented in hardware, software, firmware or a combination thereof and which resides on a mobile communication device, such as a smartphone, tablet computer, netbook computer, computer-integrated eyeglasses, computer-integrated wristwatch, wearable electronics or other mobile computing device that is capable of communicating with a network server. The scan-enabled client module may include an executable computer program (e.g., C++, Java, etc.) that is adapted to be downloaded onto the mobile communication device, installed and executed. The scan-enabled client module may also include a web browser that is adapted to access and execute web-based software (e.g., JavaScript, etc.) that provides a least a portion of the necessary scan-enabled client functionality FIG. 1 is a block diagram that illustrates an exemplary architecture of a smartphone-based scan-enabled client module. Smartphone 100 includes a camera module 102 that is adapted to capture, process and/or store an image in a digital format. Smartphone 100 also includes a scan-enabled client module 104. Scan-enabled client module 104 is comprised of scanable code reader module 106, a user interface module 108, an administration module 110, a scan control logic module 112, and a participation reward control logic module 114. Scan-enabled client module 104 may interact with a data storage module 116, a communication module 118, and a geo-location module 120. Scan-enabled client module 104 and/or one or more of the modules that make up scan-enabled client module 104 may be executable by a processor 122.

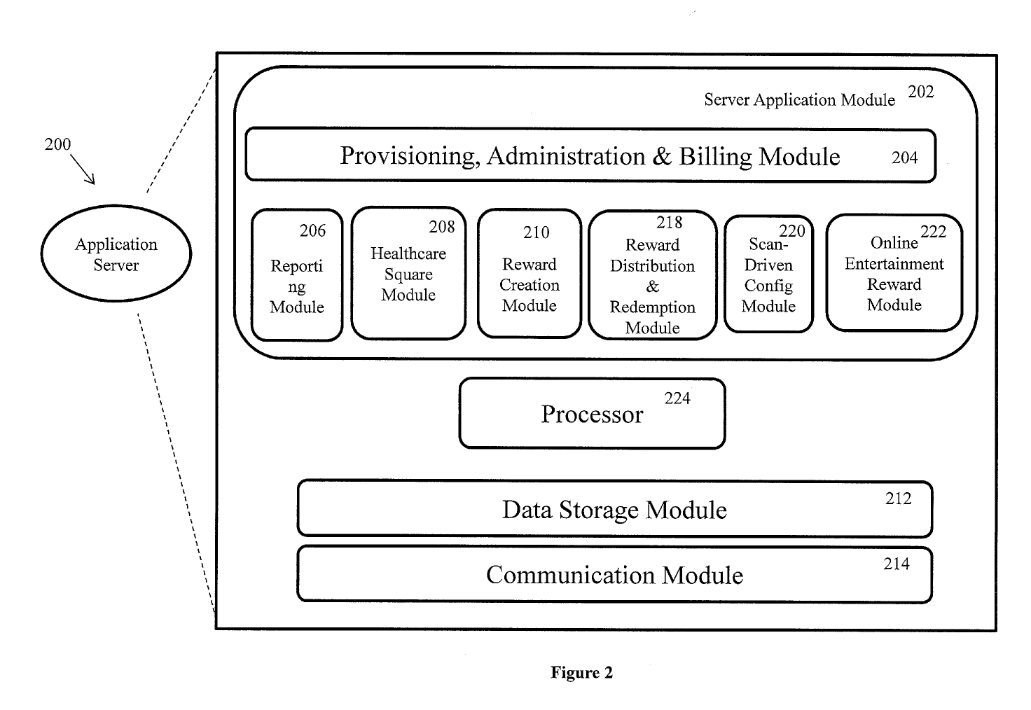

Scan-enabled client module 104 is adapted to scan and extract information from a healthcare instruction step scan code, which is subsequently provided to a scan-triggered application server that is hosting the healthcare instruction step service. The extracted scan-triggered healthcare instruction service information may comprise information that is representative, for example, of an alphanumeric text string, a numeric code. In one embodiment, the extracted scan-triggered service information may be used to identify a healthcare instruction set or template and to facilitate the providing of scan-triggered compliance incentive rewards based on the scanning of healthcare instruction service scan codes. The decoded healthcare instruction service scan code information is provided to an associated scan-triggered server application module 202 (illustrated in FIG. 2) via communication module 118. In an alternate embodiment, scan code reader module 106 is adapted to receive digital image information from camera module 102 and to communicate the digital image information (e.g., JPEG) to server application module 202 via communication module 118 where decoding processing is performed. In one embodiment, information that identifies or can be used to identify a scan-triggered service user (e.g., user name, user ID, session ID, mobile device identifier, etc.) is also provided to server application module 202.

User interface module 108 is adapted to present the mobile device user with a graphical user interface for enabling the user to generally control and operate the functionality of the scan-enabled client module 104. User interface module 108 is adapted to present healthcare instruction step information, as well as a menu structure to the user and enable the user to navigate this menu structure. The menu structure provides a user with access to administrative functions, such as scan triggered service account settings (e.g., username, password, service preferences, personal information, etc.), account log-in. Such administrative functions are controlled within scan-capable or scan-enabled client module 104 via administration module 110. The menu structure may also provide the user with the ability to control the associated smartphone camera. In some embodiments, the ability to access and operate the smartphone camera in the manner required to effectively photograph or scan an optical scan code, such as a QR code, is provided via scan control logic module 112.

In one exemplary embodiment, scan-enabled client module 104 may include a native application that is adapted to execute on mobile device 100, and in such a case that native application may include QR scanning/decoding capability or alternatively scan-enabled client module 104 may simply invoke the services of a third-party QR scanner/decoder that is installed in the mobile device. In another exemplary embodiment, a generic third-party QR scanner/decoder may be invoked by the mobile device user to scan and decode a suitably provisioned QR, where decoding of the QR code causes a web browser instance to be launched and directed to or towards a URL associated with the healthcare instruction step service hosting application server. In this case, information that identifies the relevant/necessary scan-triggered healthcare instruction set/template/service information may be passed to the application server via the URL/URL parameters. For example, in one embodiment, information that identifies a specific healthcare instruction step set or template may be explicitly or implicitly communicated to the application server via the URL itself (e.g., the host name and/or path and/or parameter components of the URL can be used by the hosting application server to explicitly or implicitly identify the healthcare instruction and reminder set, template or service). In an alternate embodiment, for example, all communications between the user's mobile device and the application server may be addressed to a URL which points to a scan-based service provider (e.g., www.PoweredByPostdoc.com), and the information that identifies the particular healthcare instruction step set or template may be communicated to the scan-based service provider's application server via the path and/or query string parameter portions of the URL. In one embodiment, such a URL address associated with the scan-triggered service platform may be encoded or otherwise incorporated into a scan code associated with a scan-triggered service platform, or which requests scan-triggered application service from a scan-triggered service platform. In one embodiment, the URL which points scan-based service provider (e.g., www.PoweredByPostdoc.com), and the information that identifies the scan-triggered service may be encrypted, such that only a particular code scanner, native mobile code scanning application, or mobile web browser with integrated code scanning capability which has access to or is provisioned with the appropriate decryption/de-obfuscation key information can decode and process the scan-triggered service URL information and thereby facilitate the providing of the associated scan-triggered service. As such, a particular scan-triggered service code may be “locked” to all code scanners but the scanner that has access to/is provided with the appropriate decrypt/de-obfuscation key information, thereby providing users with an added measure of security and privacy with respect to accessing the scan-triggered healthcare instruction step services.

In one embodiment, a menu structure provides the user with the ability to access and redeem healthcare instruction compliance incentive rewards. Compliance incentive reward access and redemption functionality is provided by reward control logic module 114. Data storage module 116 is adapted to provide both long term storage of data associated with the scan-enabled client module, as well as short term, cache-type storage of scan client related data. Exemplary uses of the data storage are discussed in more detail in the disclosure that follows.

Communications module 118 is adapted to facilitate the communication of information between scan-enabled client module 104 and server application module 202. For example, communication module 118 may receive information from scan control logic module 112 that is to be communicated to server application module 202. Communication module 118 may package the information according to a predefined message format and forward the message to a data communications interface associated with the smartphone. Exemplary data communication interfaces may include, but are not limited to, a General Packet Radio Service (GPRS) interface, an Enhanced Data Rates for GSM Evolution (EDGE), High Speed Packet Access (HSPA), WiMax, WiFi, LTE, etc. For example, in one embodiment, when a user scans a service scan code associated with a scan-triggered healthcare instruction service, communication module 118 is adapted to communicate to server application module 202 information that was encoded in the scanned healthcare instruction service code (e.g., HealthcareSquareID, MedStepSquareID, SunSafeSquareID, DosingSquareID, RxSquareID, HealSafeSquareID, etc.), as well as information that can be used to identify the user. Information that can be used to identify the user may include a user identifier (e.g., username, email address, mobile IP address, mobile device identifier, session ID, etc.). It will be appreciated that the communication of such user identifying information to the server module may be triggered upon scanning of the QR code or may be triggered upon startup of software associated with scan-enabled client module 104 (e.g., auto-login, manual login, etc.). As such, the communication of user identifying information and healthcare instruction set or template information obtained from the scanning of a scan code may be accomplished via a single message that is communicated between scan-enabled client module 104 and an associated server module, or this information may be communicated via multiple messages to the application server module.

In one embodiment, when a user presents login credentials (e.g., username and password) and is successfully authenticated, a communication channel or session is established between scan-enabled client module 104 (e.g., a smartphone web browser or native application) and server application module 202 (e.g., an application residing on a network-based host computer), and all subsequent communications made via the session or channel are associated with the user's login credential/identity information. In this way, a user's identity information may be provided before, during, or even after the scanning of an associated service scanable code (e.g., QR code, NFC code, RFID code, etc.), and thereafter bound to the information derived or obtained from scanning of the code. In another embodiment, the scanning of a scan code by a user triggers the scan-enabled client module 104 to access previously stored login credential information (e.g., user identifying login credential information stored in a file or cookie that is resident on mobile communication device 100. Scan-enabled client module 104 automatically provides the user's login credentials to the application server module, which then associates the information obtained from the scanning of the scan code with the user's scan-triggered healthcare instruction service account. Once the session is established, information obtained and provided to the application server module is automatically associated with the user's account. These same user identity binding techniques may be employed with any of the embodiments of the subject matter described herein.

Geo-location module 120 is adapted to determine geo-location information indicative of the geographic position of mobile communication device 100. Geo-location information determined by module 120 may include Global Positioning System (GPS) coordinate information (e.g., latitude, longitude, elevation). Module 120 may determine this geo-location information and generally facilitate the communication of this information to an associated server application module in conjunction with the communication of scanned graphic icon (e.g., QR code) information, thereby enabling server application module 202 to identify and store the location at which a QR code was scanned. Alternatively, geo-location or position information may be encoded in the QR code that was scanned, and once scanned the location information may be decoded by geo-location module 120 and passed along to server application module 202 associated with the scan code-based service system.

It is understood that with the addition of scan-enabled client module 104, mobile device 100 becomes a special purpose computing platform that improves the functionality of mobile device 100 by providing direct access to a server application in response to receiving a scanned code from camera module 102. Mobile device 100 with scan-enable client module 104 also improves the technical field of network access to services because such services can be accessed automatically and quickly with a reduced likelihood of data entry errors. Processor 122 is adapted to facilitate the execution of software and firmware associated with the operation of modules 106, 108, 110, 112, 114, 116, 118 and 120, which is used to provide the overall scan-enabled client module functionality described herein. Exemplary implementations of processor 122 include, but are not limited to, one or more single-core microprocessors, one or more multi-core microprocessors, and one or more programmable logic devices (e.g., a complex of programmable logic devices, a field-programmable gate array, etc.).

FIG. 2 is a block diagram that illustrates an exemplary architecture of server application module 202, which resides and executes on a network or cloud-hosted application server 200. In the embodiment presented in FIG. 2, the server application module is comprised of a provisioning, administration and billing module 204, a reporting module 206, a Healthcare Square control logic module 208, a reward control logic module 210, scan driven configuration module 220, online entertainment module 222. Server application module 202 and/or any of the modules that make up server application module 202 may be executable by a processor 224. Server application module 202 may interact with a data storage module 212 and a communication module 214. The purpose and function of each of these modules is described below. Server application module 202 executing on application server 200 makes application server 200 a special purpose computing platform that improves the functionality of application server 200 by configuring application server 200 to process received information extracted from a scanned healthcare instruction service scan code, and in some cases scanning user identification information and reference date/time information, and to provide the indicated healthcare instruction step service to the scanning user in response to receiving this information. As such, server application module 202 improves the technical fields of network access to services by providing such services automatically in response to receiving the scanned codes and with a reduced likelihood of data entry error.

Provisioning, administration and billing module 204 is adapted to provide access for a healthcare provider, healthcare goods provider or other healthcare instruction step administering entity to provision healthcare instruction step information, healthcare instruction step patient or user subscription configurations/preference information, service configuration information, and compliance incentive reward content information. In the context of this disclosure, a patient or user is considered to be the owner and/or operator of a mobile communication device (e.g., smartphone, tablet computer, etc.) that includes a scan-enabled client module, and is therefore capable of scanning a QR code (or other encoded, scanable code) and provide, trigger, initiate or facilitate access to the healthcare instruction step service.

In at least some of the embodiments disclosed herein, a scanning user may be granted or credited with a healthcare compliance incentive reward in response to the scanning or use of an associated scan-triggered healthcare instruction step service code (e.g., QR code). Exemplary compliance incentive rewards may include, but are not limited to, a digital or electronic coupon associated with a good or a service (e.g., $1 off a large Joe's Coffee, etc.), a credit for an online game or gaming service, a credit for an online video, a music or video download. Online entertainment-based compliance incentive rewards may be distributed and administered and/or redeemed by online entertainment module 222. In one embodiment, such rewards may be credited or placed in a digital reward wallet associated with the user's scan-triggered service account, whereby the user can access and redeem a granted reward. In one embodiment, a reward granted to a user may be granted at a first value (e.g., $1 off next purchase) and subsequently modified to a second value (e.g., $2 off next purchase) at a later by Reward Control Module 210.

Processor 224 is adapted to facilitate the execution of software and firmware associated with the operation of modules 204, 206, 208, 210, 212, 214, 218, 220, and 222 which is used to provide the overall server application module functionality described herein. Exemplary implementations of processor 224 include, but are not limited to, one or more single-core microprocessors, one or more multi-core microprocessors, and one or more programmable logic devices (e.g., a complex programmable logic devices, a field-programmable gate arrays, etc.).

According to one embodiment of the subject matter described herein, an identifier associated with a set of patient healthcare instruction steps is encoded within a scanable code, such as an optical scan code (e.g., QR code) which may be scanned by a user (e.g., a healthcare goods consumer, a patient, a patient guardian/caretaker, etc.). Patient healthcare instruction steps may include, but are not limited to, pre-operative surgical and diagnostic procedure preparation instructions that should be followed by a patient, post-operative procedure recovery instructions that should be followed by a patient, pre- or post-physician's office visit patient instructions, post-emergency room/urgent care visit patient instructions, physical therapy or rehabilitation therapy patient instructions, medication dose administration schedule instructions (e.g., OTC, prescription medications, etc.), and pre- or post-visit/procedure patient health status information self-report instructions (e.g., providing self-reported temperature, self-reported blood pressure, self-reported pain level information, etc.). In one embodiment, each healthcare instruction step includes relative date and time offset scheduling information that can be evaluated and resolved to absolute dates and times in the presence of a reference date and/or time that is provided by or on behalf of a specific user (e.g., patient). Various embodiments described in U.S. provisional patent filings that are incorporated by reference in this disclosure, refer to and describe exemplary implementations of such scan-triggered healthcare instruction step & reminder services in the form of RxSquare, MedSquare, DosingSquare, HealSafeSquare and SunSafeSquare branded services.

In one embodiment, healthcare instruction step information is logically organized into instruction sets or templates where, each set or template is associated with a specific set of healthcare instructions (e.g., colonoscopy screening pre- and/or post-procedure instructions, medication dosing amount and schedule instructions for a 10 day course of penicillin, minimum time to next dose of an over the counter pain reliever, dental hygiene instruction schedule, etc.). In an alternate embodiment, each healthcare instruction set or template is associated with a user (e.g., a set of healthcare instructions for patient X, etc.). Healthcare instruction and reminder service identifiers, such as instruction set or template identifiers are used to map/associate/bind a provisioned healthcare instruction set or template with a scanable code, and this binding information is stored at or is accessible to a scan-triggered application server. Exemplary healthcare instruction set identifiers described previously include, a MedStepSquareID identifier, an RxSquareID identifier, a HealSafeSquareID identifier, a DosingSquareID identifier and SunSafeSquareID identifier. In one embodiment, a healthcare instruction set identifier may be incorporated into the network address of a server that is hosting the scan-triggered healthcare instruction & reminder service. For example, information sufficient to identify a particular healthcare instruction set may be incorporated within or expressed within a domain name (e.g., Postdoc2324.com) associated with the scan-triggered healthcare instruction & reminder service. In another embodiment, information sufficient to identify a particular healthcare instruction set may be incorporated within or expressed in as an argument or parameter associated with a URL (e.g., Postdoc.com/webhp?sourceid=chrome-instant&HealthSquareID=2342). In any event, information extracted from a scanned healthcare instruction service scan code by a scanning mobile device is provided to the hosting healthcare instruction & reminder service server and this information is used, at least in part, to identify healthcare instruction set content.

In one embodiment, a “generic” healthcare instruction set or template that includes general patient instructions for a routine colonoscopy screening procedure may be defined and associated with a unique healthcare instruction set identifier that is assigned and/or maintained by a network application server that is hosting the scan-triggered healthcare instruction & reminder service. The healthcare instruction set identifier may be encoded within a scanable code, such as a QR code. Alternatively, the healthcare instruction set identifier may be mapped to or associated with a second, internal identifier, which is then encoded within the scanable code. In any case, the healthcare instruction set identifier encoded in the scanable code can be used, at least in part, by a scan-triggered application server of the present invention to identify a healthcare instruction set. In one exemplary embodiment, when such an identifier is received by the application server that is hosting the scan-triggered healthcare instruction & reminder service, the identifier is used to access the associated “generic” healthcare instruction set template and provide healthcare instruction step service to the scanning user. In one embodiment, a reference healthcare event time (e.g., date and time, 1/2/2016 @ 2:00 pm, date only, time only, etc.) is provided by and/or associated with a scanning user. Again, as used herein, a reference time may include date and time, date only, or time only and may be referred to within this and other disclosures as date/time for purposes of illustration and brevity. The scanning user's reference healthcare event date and/or time is applied to instruction step relative temporal scheduling offset information, such as date and/or time scheduling offset information, contained in the “generic” healthcare instruction set template, so as to generate a resolved temporal scheduling value for the scanning user. Exemplary resolved temporal scheduling values include, but are not limited to, absolute date/time (e.g., 5/6/2015 @ 1:00 pm), and a countdown timer value (e.g., 90 minutes until the next healthcare instruction step needs to be performed). For the purposes of illustration, absolute date/time resolution is often referred to in the exemplary embodiments described herein, but it will be appreciated that any resolved temporal scheduling value could be used. For example, an instruction step in a generic colonoscopy screening healthcare instruction template may include a relative date/time offset, which specifies that the step is to be completed 36 hours prior to the time of the scheduled colonoscopy procedure. This “generic” instruction step may be applied to any number of scanning users/patients, and as such the same scanable QR code may be provided to all routine colonoscopy screening patients of an endoscopic medical practice that is providing routine colonoscopy screening services to patients. As each patient user scans this scanable code, they each provide their own reference date, which is then used to resolve the relative date/time offsets in the generic instruction set template such that different absolute instruction schedules are generated for each scanning patient user. Such resolved absolute instruction schedules may be dynamically created/re-created each time a user scans the healthcare instruction service scan code, or the resolved absolute instruction schedule may be determined once and stored for future use on each subsequent scan by the patient user.

In one embodiment, as each patient scans the healthsquare QR code, a user identifier is assigned to each patient (if one has not already been assigned) and they are prompted to provide their scheduled colonoscopy screening appointment date and time (i.e., a healthcare event reference date/time). The colonoscopy screening appointment date and time provided by (or on behalf of) a patient is associated with that patient's user identifier and, in one embodiment, this association is stored in a binding record that is maintained or is accessible to the application server that is hosting the scan-triggered healthcare instruction step service. When the patient makes subsequent scans of the same QR code, the patient's user identifier (e.g., which may be stored in a cookie on the patient's mobile device) is automatically communicated to the hosting scan-triggered server along with the healthcare instruction set identifier extracted from the scanable code, and the user identifier information is used to access that patient's healthcare event reference date/time. The healthcare instruction set identifier is used to access the associated “generic” healthcare instruction step template for a routine colonoscopy screening, and the patient's healthcare event reference date/time value is used to resolve the relative date/time scheduling offsets contained in the instruction step template, as described previously. The hosting server then communicates the date/time-resolved healthcare instruction step information to the scanning patient, where it is displayed in chronological order. Current date/time information may be used to present the scanning user with those instruction steps that are most relevant at the current date/time (e.g., when the user scans the QR code, the current day/time instruction steps are displayed). In this embodiment, multiple copies of the same scanable code (e.g., a QR code associated with routine colonoscopy screening) may be generated and given to multiple different patients, which each may use them to obtain healthcare instruction step information that is date/time-resolved specifically for each of them. This approach has significant advantages from the administrative perspective of the healthcare provider, as the same scan code can be handed out to all patients who are undergoing the same healthcare procedure (e.g. routine colonoscopy).

In an alternate embodiment, a “generic” healthcare instruction step template is defined and stored/accessible to the hosting scan-triggered application server. When a patient initially scans the associated scanable code in a manner similar to that previously described and provides a reference healthcare event date and/or time, the scanning user's reference healthcare event date and/or time is applied to instruction step relative date/time scheduling offset information contained in the “generic” healthcare instruction set template, so as to determine absolute scheduling dates/times for the scanning user. In one embodiment, a copy of the “generic” template is created and associated with the scanning patient (e.g., associated with the scanning patient's user identifier). This patient-specific instance of the healthcare instruction step template includes resolved date/time information (that is determined based on the reference date/time provided by the patient, in a manner similar to that previously described). Once created, this patient-specific instance of the healthcare instruction set may be modified, for example by the patient's healthcare provider. Such modifications do not impact the “generic” template, but instead are associated with the specific patient. Again, one key advantage of this approach is from an administrative perspective. For example, the same QR code can be provided to multiple patients who are to undergo a routine colonoscopy screening. Once each patient scans the QR code and their user identifier is provided to the hosting scan-triggered application server (along with the healthcare instruction set identifier and their reference date/time information), a healthcare provider can access the patient's copy of the instruction set and edit, delete, add or otherwise adjust any of the instruction steps for that patient. Such access may, for example, be provided to a physician via a provisioning interface that may be accessed via the healthcare provider's computer or mobile device.

In another embodiment, unique instruction sets may be created and/or maintained by the hosting scan-triggered server for each patient, and a unique healthcare instruction set identifier assigned to each patient-specific instruction set. In one embodiment, each scanable code (e.g., QR code) generated includes a different, unique healthcare instruction set identifier value, which has been or can be assigned to a specific patient. This approach inherently requires the creation of multiple, unique QR codes (e.g., each patient who is going to undergo a routine colonoscopy would be given a QR code that includes a unique/different healthcare instruction set identifier value). The advantage of this approach offers involves the elimination of the need to for the scanning patient to be assigned and to provide a user identifier, and as such, the described healthcare instruction step services can be provided in an anonymous manner. In one embodiment, the associated healthcare procedure reference date/time may be provided/collected in a manner similar to that previously described, or alternatively, reference date/time information may be pre-provisioned for a unique QR code via a provisioning interface available to a healthcare provider. As such, a patient could simply be given a pre-provisioned, unique scanable code, which does not require them to provide user identification or reference date/time information.

In various embodiments, scanning user identifying information may include, but is not limited to, a user identifier assigned by the hosting scan-triggered application server (or service provider), such as for example, a username, email address, phone number, scan-triggered service account identifier, or a mobile device identifier (e.g., an identifier, which may be assigned by a scan-triggered server/service provider, that is stored in a cookie on a mobile device associated with the user or patient, etc.).

In one embodiment, information that can be used to identify a network application server that is hosting or providing the scan-triggered healthcare instruction & reminder service is also encoded within the scanable code. In one example, such network application server identifying information may include, but is not limited to, an Internet protocol address, a network server address, a network resource address, and a uniform resource locator or identifier and/or associated parameters and argument values. This approach is advantageous in that a user or patient is not required to download and install a native application that is designed specifically to provide healthcare instruction step & reminder service, and instead, any generic QR code scanner application residing on the user's mobile device is inherently capable of accessing various embodiments of the scan-triggered healthcare instruction step and reminder service of the present subject matter.

In one embodiment, healthcare instruction set compliance (i.e., has the step been successfully completed) may be self-reported by a scanning patient user. For example, following the scan of a healthcare instruction step associated QR code, the scanning user is presented with a chronologically ordered list of healthcare instruction steps, where each instruction step includes a tap-able compliance indicator control (e.g., check box, etc.). Instruction step information provided to the scanning user is aligned to the current date/time at the time of the scan (i.e., instruction(s) relevant at the time of the scan are highlighted or preferentially displayed). When tapped or selected by the user, compliance information for the associated step (e.g., user identifier, instruction step identifier, date/time, etc.) is communicated to the hosting scan-triggered application server, where it is stored in a record that is associated with or bound to the user. In another embodiment, a user scan of a healthcare instruction set QR code causes associated healthcare instruction set identifier and user identifier information to be communicated to the hosting scan-triggered application server, where it is interpreted by the server as a compliance indication signal.

In one embodiment, a compliance incentive reward is associated with timely completion of one or more healthcare instruction steps. Compliance incentive reward criteria and associated digital reward(s) are associated or bound to a healthcare instruction set or template. If a patient user scans a healthcare instruction set QR code and signals compliance so as to satisfy the associated compliance incentive reward criteria, a digital reward is credited. In one embodiment, a granted compliance incentive reward may be credited to a digital reward wallet associated with the user. Exemplary digital rewards may include, but are not limited to, a digital coupon for a good or service, an online game credit (e.g., a credit for a free game, a credit for a game “mod” (e.g., Minecraft mod, etc.)), an online game asset credit (e.g., a credit for a virtual asset associated with an online game, such as an extra life, extra points, extra power, extra playing time, etc.), an online video streaming credit, an online streaming music credit. With regard to online game, video and music related rewards, it will be appreciated that the associated online game, video or music services may be provided by a game or media content server other than the scan-triggered healthcare service application server. Such online game, video or music credits may, for example, be automatically, immediately redeemed at the time of issuance or the reward credits may be placed in a digital reward wallet associated with the user.

In one embodiment, a compliance guardian is associated with a user and one or more healthcare instruction steps. A message notifying the compliance guardian that the associated user is non-compliant/has not reported compliance of the associated healthcare instruction step is generated and transmitted. For example, a mobile phone number associated with a compliance guardian may be provisioned, such that the designated compliance guardian receives a text message notifying them of the patient user's non-compliance. In another embodiment, the non-compliance notification message may be communicated to the compliance guardian via a social network message post (e.g., Facebook post) or a social media messaging service, such as Twitter using a tweet.

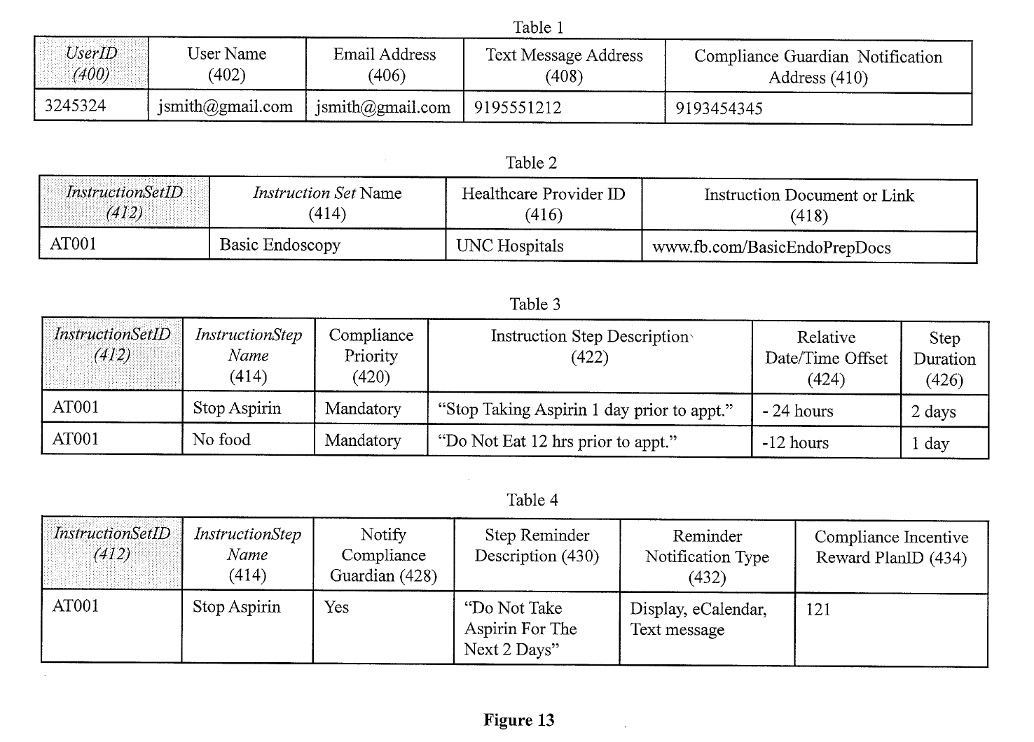

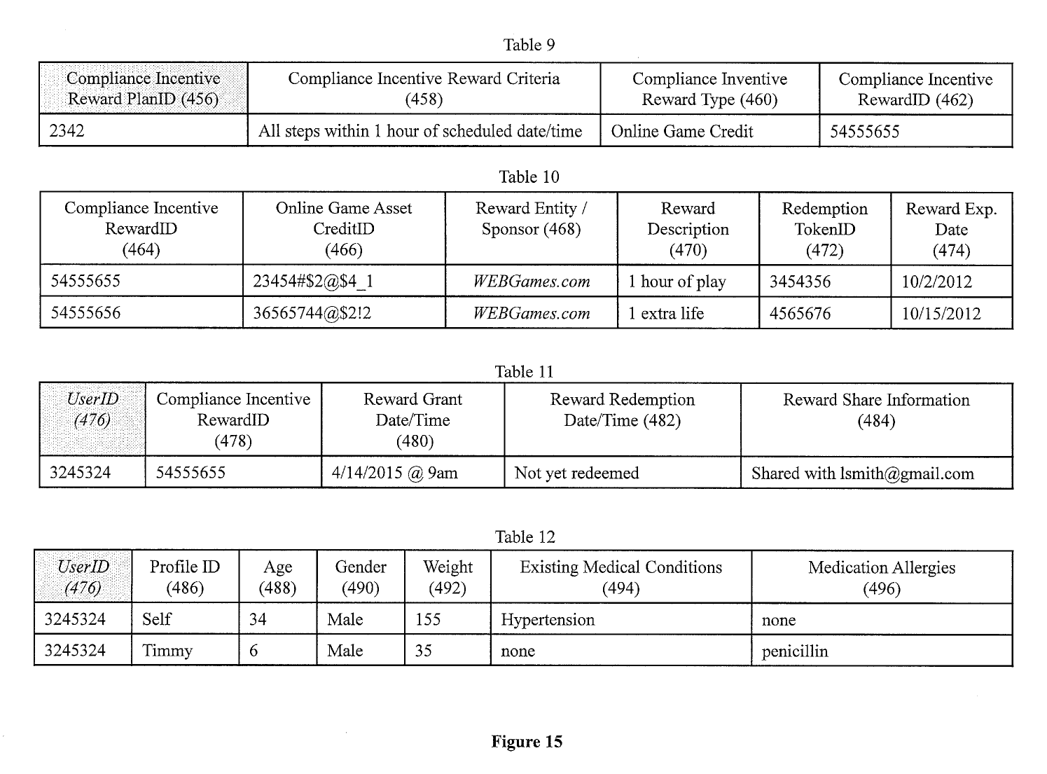

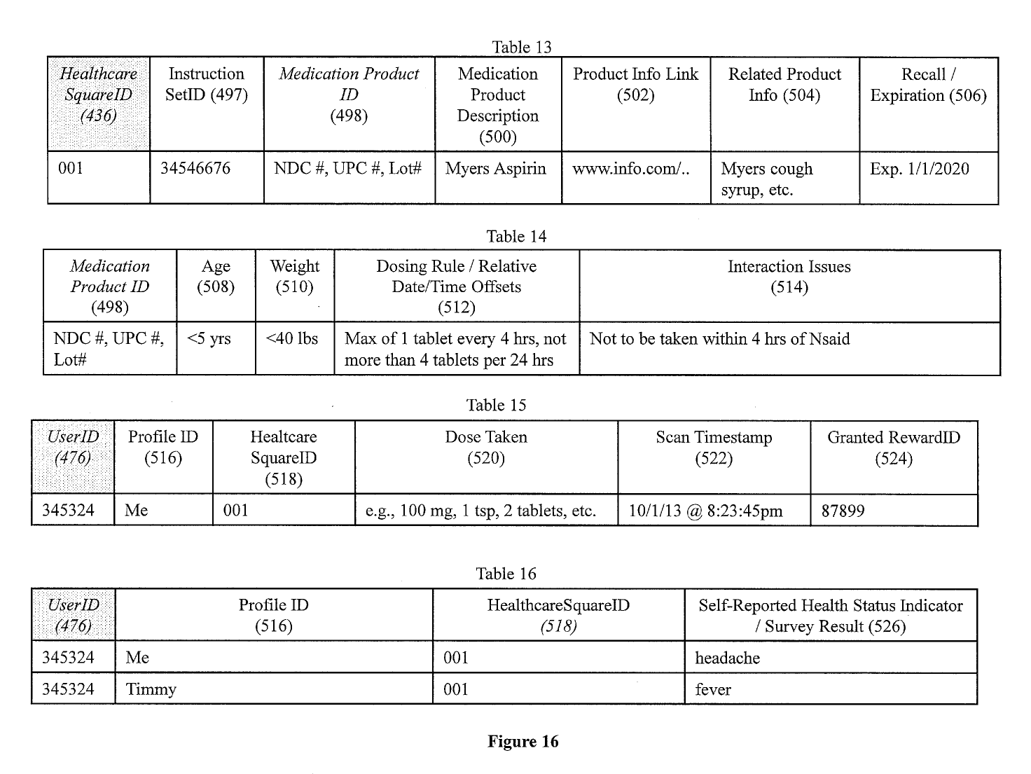

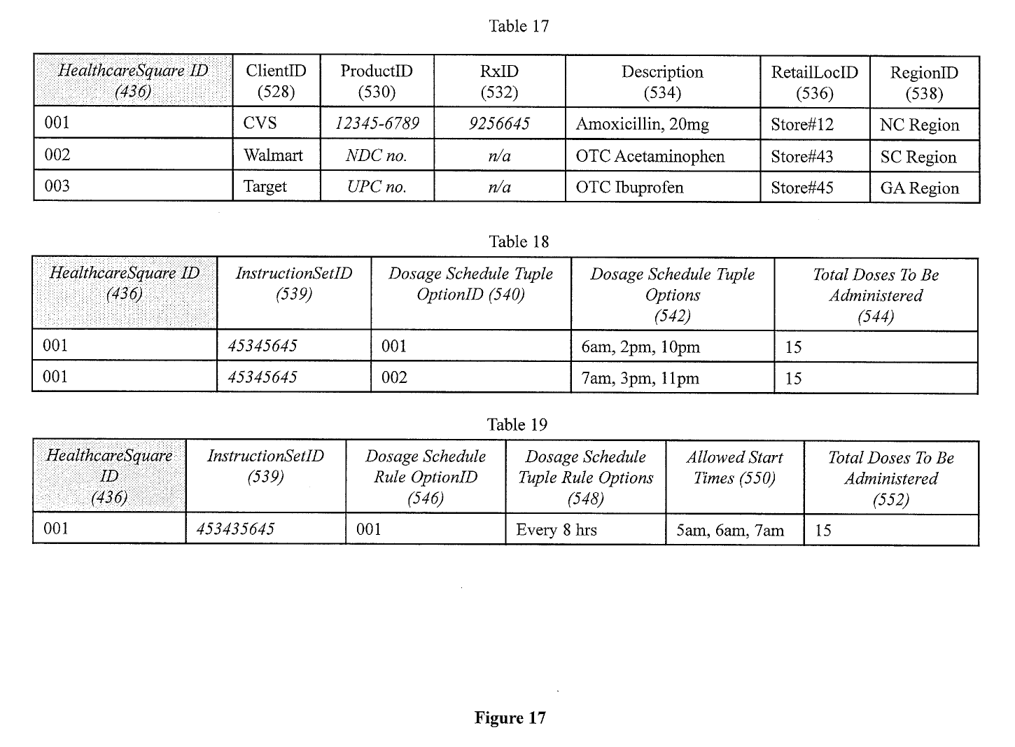

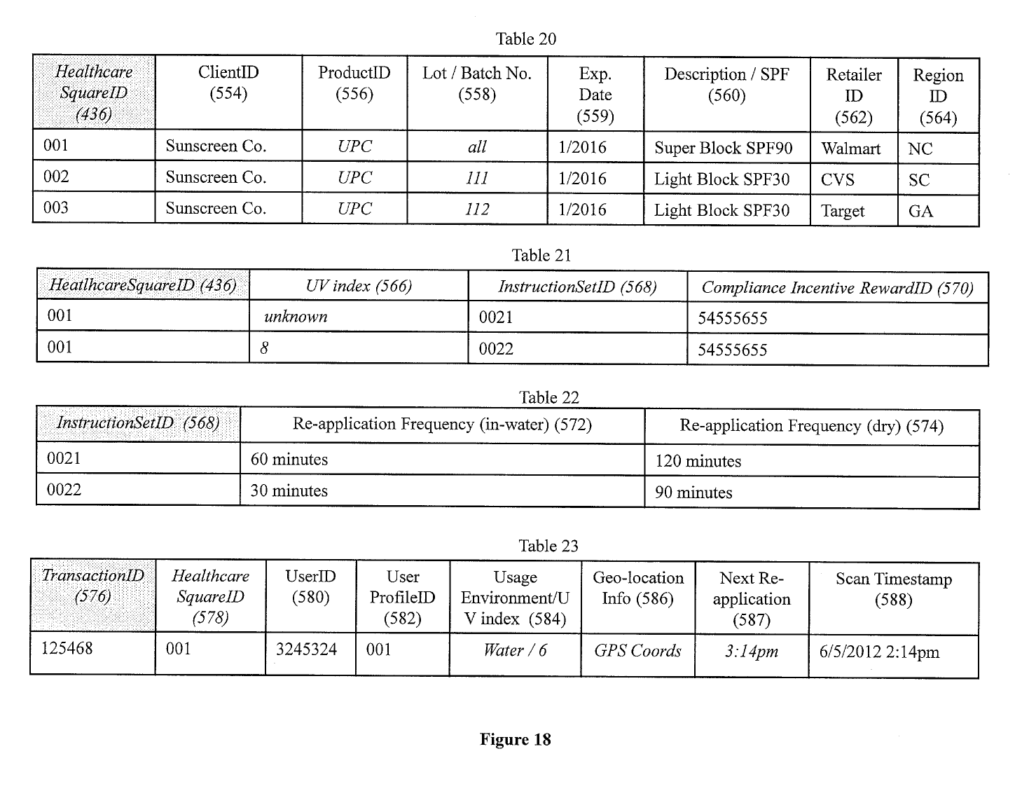

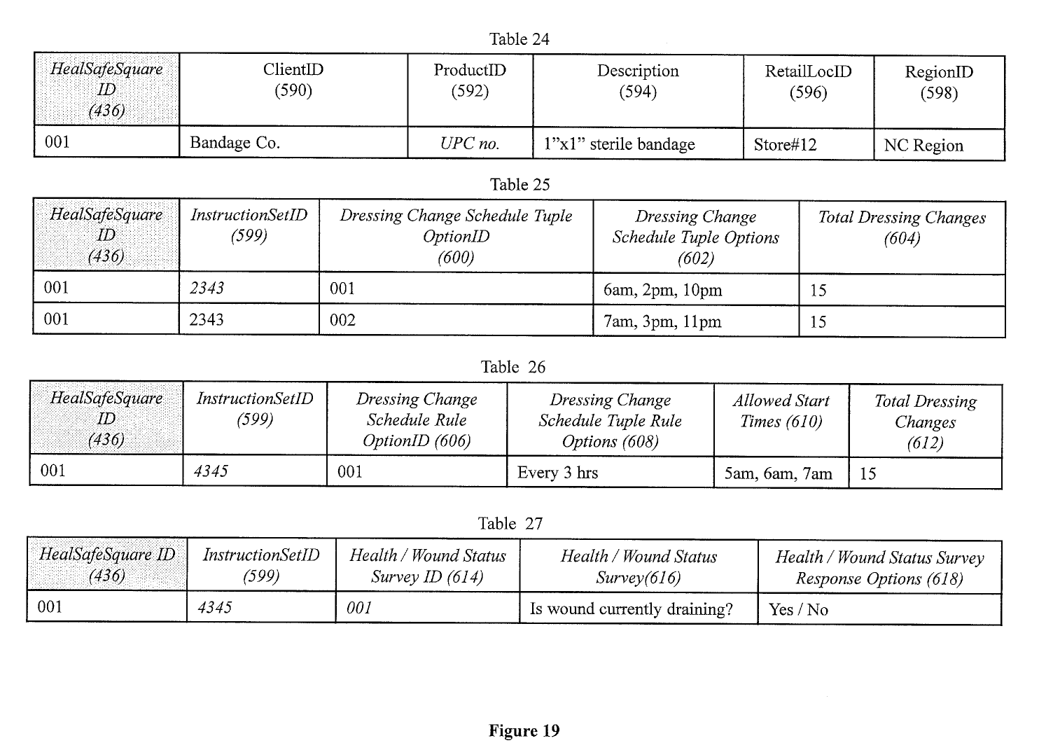

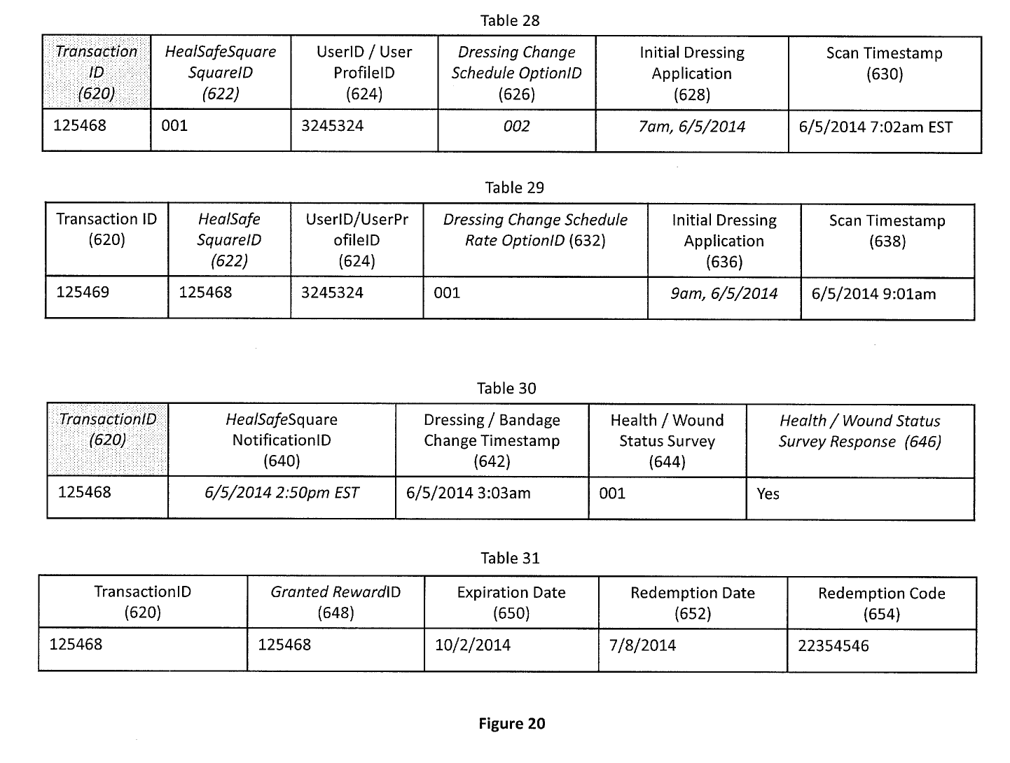

Described below are various exemplary embodiments of scan-triggered healthcare instruction step service of the present subject matter. Presented in FIGS. 13-20 is exemplary provisioning and transaction data associated with various exemplary embodiments of the present subject matter. FIG. 13, Table 1 includes exemplary healthcare instruction service user information including a user identifier 400, user name identifier 402, email address identifier 406, text message/mobile phone number identifier 408 and a compliance guardian/notification address identifier 410. Table 2 describes exemplary healthcare instruction set or template information, which includes an instruction set or template identifier 412, instruction set or template name identifier 414, a healthcare provider identifier 416, and an instruction set information web link or URL 418. Table 3 further describes includes exemplary healthcare instruction set or template information, which includes an instruction step identifier or name 414, an instruction step compliance priority indicator 420, instruction step description information 422, instruction step relative date/time offset information 424, and instruction step duration information 426. Table 4 further describes includes exemplary healthcare instruction set or template information, which includes compliance guardian notification setting indicator 428, an instruction step reminder text description 430, a reminder notification type indicator 432 and a compliance incentive reward or reward plan identifier 434.

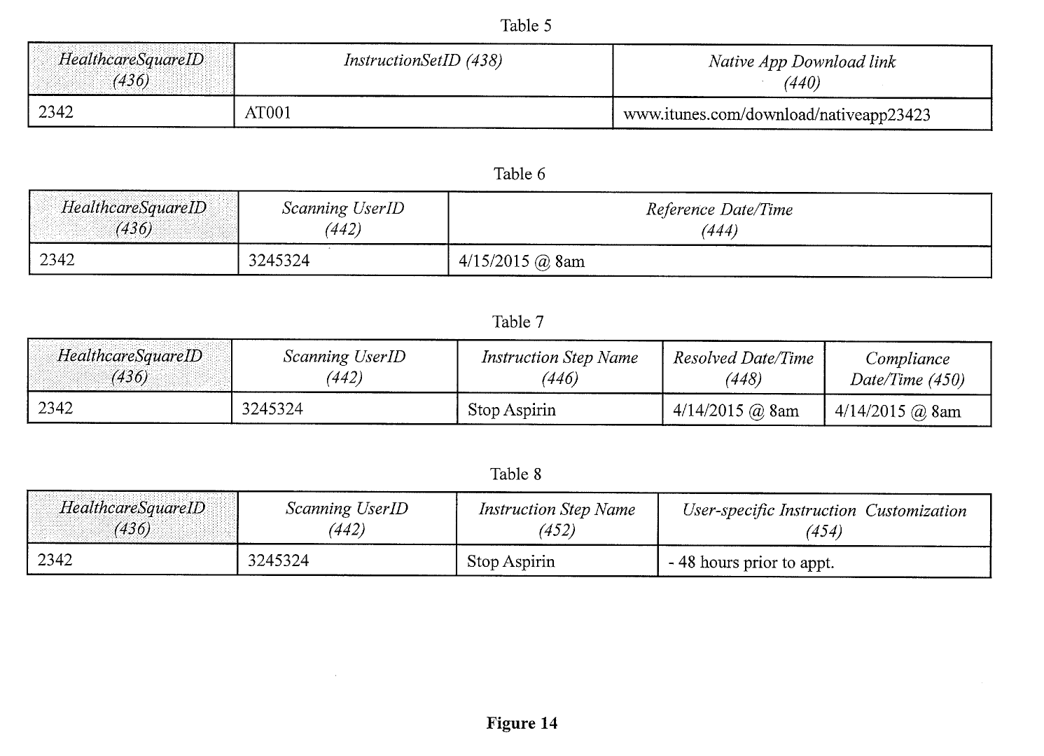

FIG. 14, Table 5 includes exemplary healthcare instruction service scan code information, which includes a HealthcareSquareID identifier value 436. It will be appreciated that in previously provided exemplary branded embodiments of the present subject matter, such identifiers were referred to as MedSquare identifiers, RxSquare identifiers, HealSafeSquare identifiers, DosingSquare identifiers and SunSafeSquare identifiers. Table 5 also includes an associated Instruction set or template identifier 438 and a native app download link 440. Table 6 illustrates exemplary scanning user-specific binding record information, including a scanning user identifier 442 and reference date/time information 444. It will be appreciated that reference date/time information may be explicitly provided by a scanning user (e.g., manually entered via a data collection screen on their mobile device following a scan), or implicitly determined as being associated or coincident with the date/time of the scan (e.g., the date/time that scan data is received at the hosting scan-triggered server, the date/time determined by a clock on the mobile scanning device, etc.). As such, in various embodiments, the hosting scan-triggered server may determine or assign a reference date/time based on the received scan information or the hosting scan-triggered server may determine a reference date/time based on date/time timestamp information associated with or contained in the communication messages exchanged between the user's mobile device and the server. Table 7 further describes scanning user-specific binding record information, including instruction step name or identifier 446, resolved date/time information for the associated instruction step 448, and instruction step compliance date/time information 450 (i.e., when did the user signal compliance/completion of the associated instruction step).

Table 8 illustrates exemplary user or patient-specific customization of an instruction set or template. Included is a HealthcareSquareID identifier 436, scanning user identifier 442, instruction step name or identifier 452, and user customization information related to the associated instruction step. It will be appreciated that new steps may be added for a particular user that are not present in the “base” instruction set or template, and that existing steps may be deleted for a particular user.

Table 9 illustrates exemplary compliance incentive reward/reward plan information, which includes a compliance incentive reward plan identifier 456, compliance incentive reward criteria 458 (i.e., rules that define what/when/how many instruction steps must be completed to be eligible for a particular compliance incentive reward, etc.), compliance incentive reward type 460 (e.g., online game, digital coupon, online video, online music stream or download, etc.), compliance incentive reward identifier 462. Table 10 illustrates one example of compliance incentive rewards, where the rewards are associated with an online game or game asset credit. Table 10 includes compliance incentive reward identifier information 464, online game or online game asset credit identifier information 466, reward sponsor or provider identifier information 468 (i.e., an identifier associated with the provider of the associated online game service, etc.), reward description information 470, reward redemption token identifier 472 (e.g., a digital token that may be provided to the user, which may then be used to redeem the associated reward) and reward expiration date information 474. Table 11 illustrates exemplary compliance incentive reward grant and redemption data, including a user identifier 476 associated with a user to which a compliance incentive reward has been granted, granted compliance incentive reward identifier information 478, reward grant timestamp information 480, reward redemption status/timestamp information 482, reward share information 484 (e.g., identifiers associated with another user, with whom the reward has been shared, gifted, or transferred).

Exemplary Pre-/Post-Procedure Patient Healthcare Instruction Embodiment

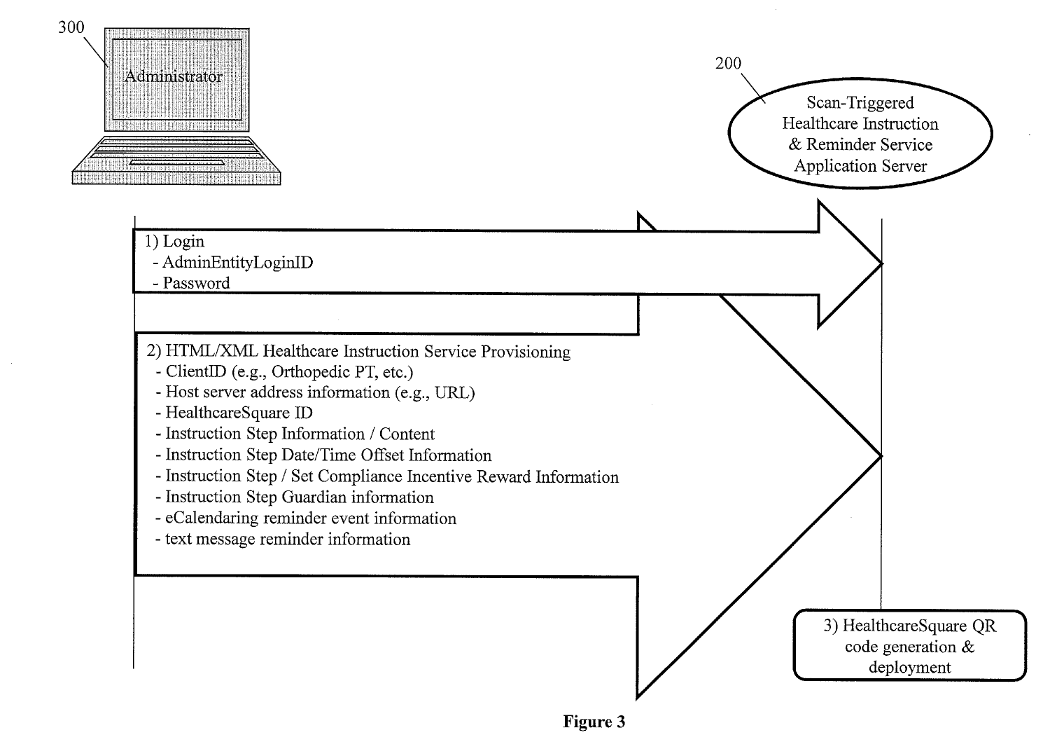

Shown in FIG. 3 is an exemplary embodiment of the present healthcare instruction and reminder service associated with a pre- and/or post-medical surgical or diagnostic procedure. (In previous associated disclosures, examples of this service were referred to as MedSquare and/or MedStepSquare service.) An administrator 300 (e.g., healthcare provider, electronic medical records vendor, physical therapist, nurse, etc.) logs into a provisioning interface associated with scan-triggered healthcare instruction and reminder service application server 200 (step1). In one embodiment, healthcare instruction and reminder service provisioning information, such as that shown in Tables 2-5, 9 and 10 (along with other service data, not shown) is provisioned and stored/made accessible to scan-triggered application server 200. A HealthcareSquareID is generated and associated with the provisioned instruction step and reminder set or template, and an associated scanable code is created that includes the encoded HealthcareSquareID. In one embodiment, information that can be used to identify an application server associated with the healthcare instruction and reminder service is also encoded in the scanable code (step 3).

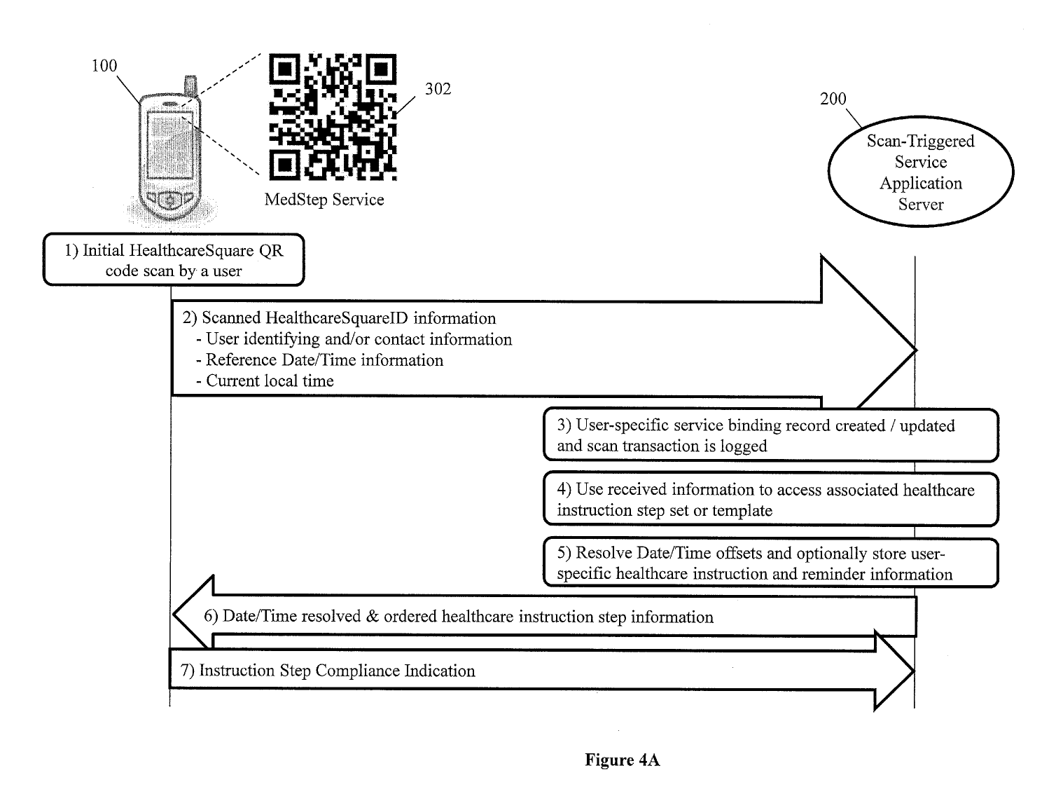

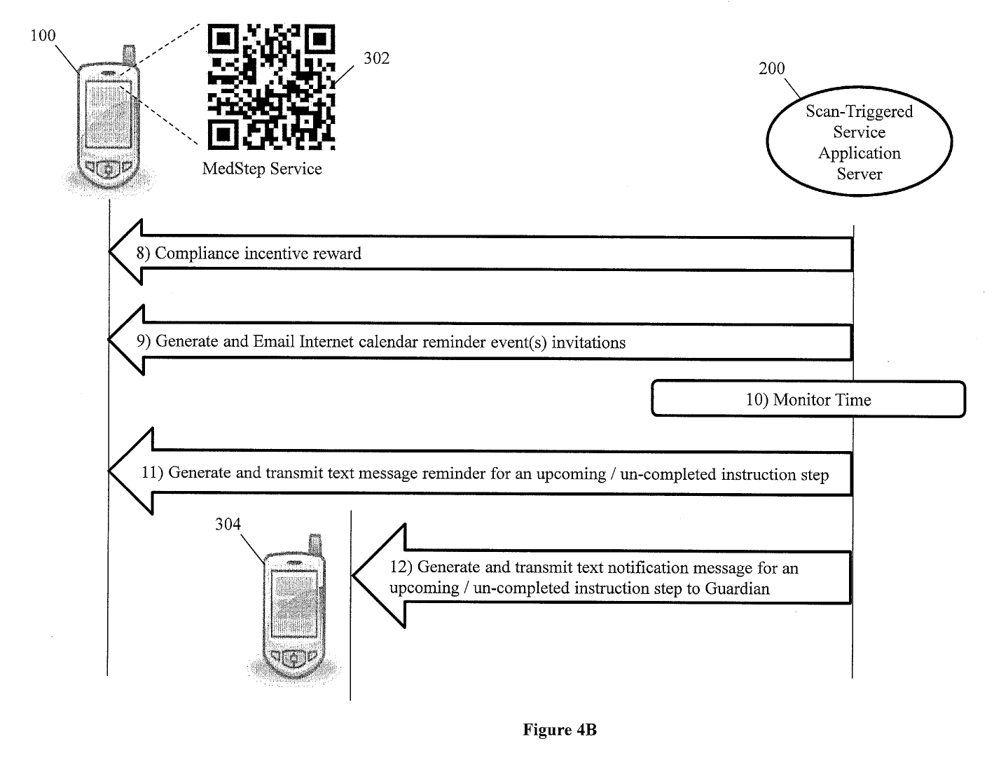

Shown in FIGS. 4A-4B is an exemplary information and process flow diagram associated with one embodiment of the present scan-triggered healthcare instruction and reminder service, which includes a scanning user 100 (e.g., patient), a healthcare instruction and reminder service scan-code 302 (e.g., MedStep Square, etc.) and scan-triggered healthcare instruction and reminder application server 200. In step 1, user/mobile device 100 scans code 302 for the first time. A HealthcareSquareID value encoded within the scan code is extracted by the scanning mobile device and communicated to server 200, in the form of a healthcare instruction and reminder service request. In various embodiments, which apply to all of the examples described herein, a healthcare instruction and reminder service request may be comprised of a single message or multiple messages. Also communicated to server 200 is a user identifier or user identifying information. For example, such user identifying information may be obtained, at the time of the scan, from a login credential cookie that was previously placed on the user's mobile device by server 200, a mobile device identifier associated with mobile device 100, or may be manually entered by the scanning user. Reference date/time information is also communicated to or determined by server 200. For example, a reference date/time may be manually entered by the scanning user or may be automatically communicated to server 200 by the user's mobile device, or the server 200 may implicitly determine the reference date/time based on the date/time that scan information was received from the scanning user, or from transmit timestamp information contained in the messages received from mobile device 100. Exemplary reference date/time information may be associated with a surgical or diagnostic procedure appointment date/time, a healthcare provider office visit, a physical therapy appointment, a hospital discharge event, a pre-procedure appointment, a follow-up appointment, etc. In step 3, the received HealthcareSquareID, user identifier information, and reference date/time information are associated/correlated and stored in a binding record by Healthcare Square module 208 on server 200. Exemplary user binding record information is shown in Tables 6-8, and 11. In step 4, the received HealthcareSquareID (e.g., AT001) is used by module 208 to access store healthcare instruction set or template information, such as that shown in Tables 2-5. In step 5, the received or determined reference date/time information is applied to the healthcare instruction set or template information, so as to resolve the relative date/time offsets for each instruction step to an absolute date/time for scanning user 100. In step 6, the resolved, chronologically ordered instruction step schedule information is communicated to the scanning mobile device 100 and displayed to the user on-screen. In one embodiment, current date/time information at the time of the scan is used to align or synchronize the presented instruction step information to the current date/time. For example, if user 100 scans the QR code at 8:30 am on 4/24/2015, the instruction step information that is communicated and displayed is aligned to the instruction step or steps that are scheduled at or near 8:30 am on 4/24/2015. In one embodiment, instruction steps that occur in the future can be viewed by user 100 by browsing forward in time through the chronologically ordered instruction step information provided by server 200, and likewise steps that occur in the past may be viewed by browsing backwards in time.

In one embodiment, the resolved instruction step schedule information associated with the scanning user 100 is stored in a user-specific binding by module 208 once it is computed, such as is shown in the resolved date/time field of Table 7. In other embodiments, only the user's reference date/time is stored by module 208, and absolute instruction step schedule information for the user is re-computed “on the fly” each time user 100 subsequently scans code 302. In one embodiment, an instruction step associated with user 100 may be added/deleted or modified/customized, such that the customization of steps in an instruction set or template is associated only with user 100. Such instruction step customizations may be performed by an administrator, such as a healthcare provider or other guardian/advocate, and stored in a binding record associated with the user, such as is shown in Table 8. As such, only user 100 will see instruction set or template customizations associated with user 100, when code 302 is scanned (i.e., other users who scan code 302 will not see or be presented with user 100's customizations).

In step 7, user 100 may signal module 208 that one or more instruction steps have been completed by sending an instruction step compliance signal or indication, where the instruction step compliance indication includes information sufficient to identify the complied with instruction step(s). In step 8, reward creation module 210, reward distribution and redemption module 218, and/or online entertainment reward module 222 associated with server 200 are adapted to received and/or process instruction step compliance indication information associated with user 100 and, based on provisioned instruction compliance incentive reward rules, grant the user a compliance incentive reward. Compliance incentive rewards may include any of the types discussed and described previously in this and other disclosures associated with the present subject matter (e.g., digital coupons, online games, video, music, entertainment services, etc.). In exemplary embodiments, granted compliance rewards may be automatically instantly redeemed at the time of grant, or may instead be credited to a digital reward wallet associated with the user's scan-triggered healthcare instruction and reminder service account and redeemed at the user's discretion.

In step 9, module 208 is adapted to generate electronic calendar “reminder” event invitations (e.g., Google Calendar invitations, etc.) associated with one or more of the instruction steps associated with scan code 302. Such electronic calendar reminder event invitations may be created using standard, well-known electronic calendaring protocols, such as iCalendar or other standardized formats. Such instruction step reminder event invitations may be communicated to user 100 via email, text message service, social media messaging service, etc. If the user accepts the associated instruction step event invitation, the associated instruction step reminder event is placed on the user's electronic/Internet calendar (e.g., Google Calendar, etc.) and associated reminder alarms may fire at the appropriately designated dates/times so as to remind the user to complete one or more instruction steps.

In step 10, module 208 on server 200 is adapted to monitor the passage of time following the user's initial scan of code 302. In step 11, module 208 is adapted to generate and transmit reminder notification messages to user 100 (e.g., via email, text message, social media message post, Twitter, etc.) for those instruction steps that the user 100 has not yet signaled/indicated as being complied with/completed. Exemplary reminder notification message information is shown in Table 4.

In step 12, module 208 is adapted to utilize designated healthcare guardian contact information that has been previously provisioned by or on behalf of user 100, and to communicate non-compliance alert notification messages to the user's designated compliance guardian 304. Exemplary compliance guardian contact address information 410 is shown in Table 1. In one embodiment, each provisioned instruction step may include a compliance guardian notification selector 428 (as shown in Table 4), which is used by module 208 to determine whether non-compliance of an instruction step should trigger a notification to be sent to the user's designated compliance guardian. In one embodiment, module 208 is adapted to communicate a compliance notification alert message to a user's designated compliance in advance of the compliance deadline for an associated instruction step, so as to pre-emptively notify the compliance guardian that an instruction step, while not yet overdue, is nearing a compliance deadline.

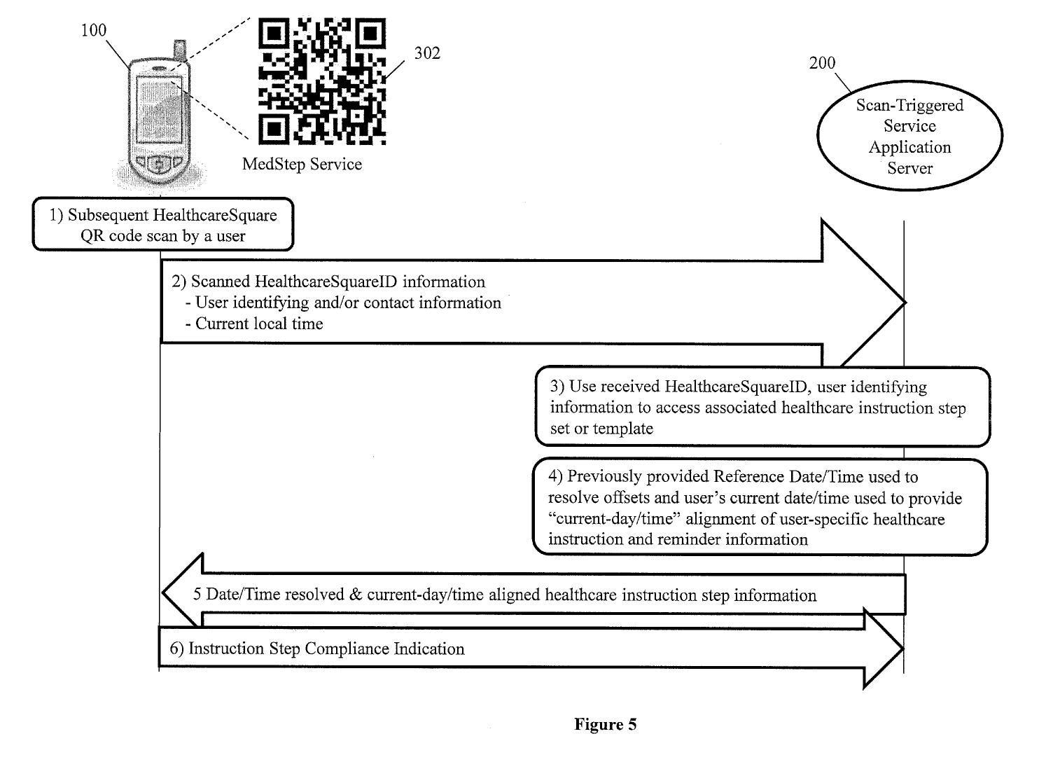

Shown in FIG. 5 is an exemplary information and process flow diagram associated with a subsequent user scan of code 302, according to one embodiment of the present scan-triggered healthcare instruction and reminder service. In step 1, user/mobile device 100 scans code 302 subsequent to the initial scan (as illustrated in FIGS. 4A-4B). In step 2, the HealthcareSquareID value encoded within scan code 302 is extracted by the scanning mobile device and communicated to server 200, in a manner similar to that previously described. Also communicated to server 200 is a user identifier or user identifying information. Current local date/time information may also be communicated to server 200, or server 200 may consult an alternate time source to obtain current date/time information. In one embodiment, the received HealthcareSquareID information is used to access the associated instruction set or template, and the user identifier information is used to access the previously created user-specific binding record to obtain the user's associated reference date/time information. The reference date/time information is then applied to the instruction set or template to resolve the relative date/time offsets for the user, as previously described. In another embodiment, the user identifier is used to access previously resolved instruction step schedule information that was stored by and is accessible to module 208. In steps 4 and 5, the resolved, chronologically ordered instruction step schedule information is communicated to the scanning mobile device 100 and displayed to the user on-screen. In one embodiment, current date/time information at the time of the scan is used to align or synchronize the presented instruction step information to the current date/time, in a manner similar to that previously described. In step 6, user 100 signals module 208 that one or more instruction steps have been completed by sending an instruction step compliance signal or indication, where the instruction step compliance indication includes information sufficient to identify the complied with instruction step(s). Compliance incentive rewards also may be granted and distributed, in a manner similar to that previously described.

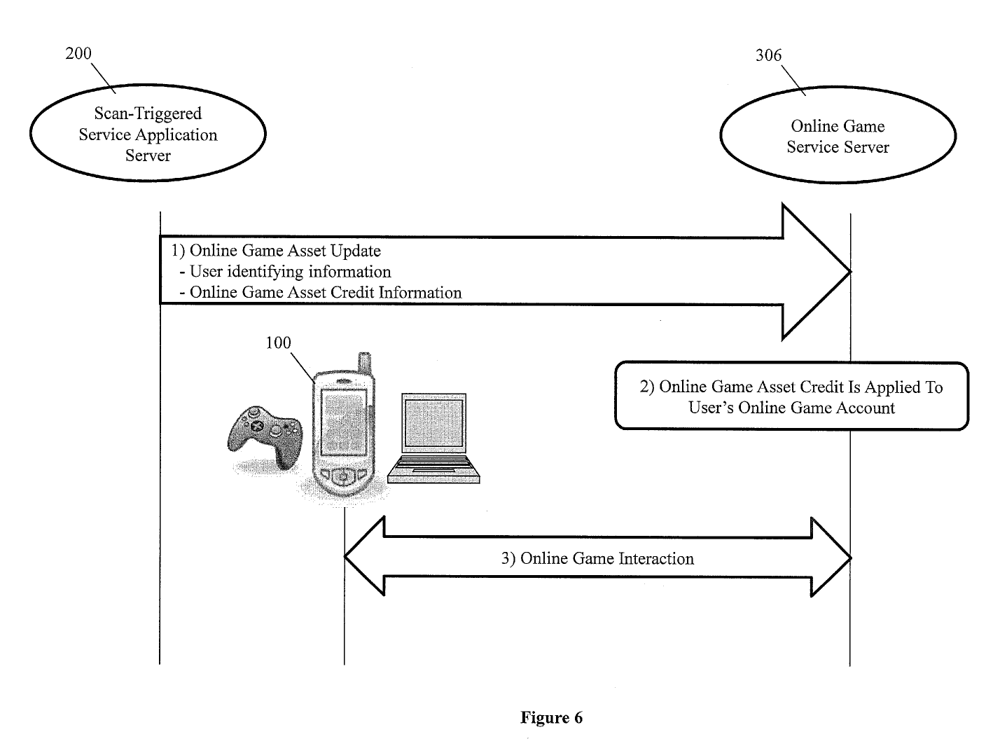

Shown in FIG. 6 is an exemplary embodiment of the present subject matter that includes the distribution of a compliance incentive reward in the form of an online game credit or online asset credit. Tables 10 and 11 illustrate exemplary online game asset credit-type compliance incentive rewards that may be distributed to scanning users of the healthcare instruction and reminder service. As used herein, the term online game asset credit is used to refer to a credit that can be redeemed for the playing of an online game and/or a credit that can be used to obtain or gain access to an “asset” associated with an online game. Exemplary online game assets may include, but are not limited to, extra game playing time, extra power, extra lives, extra characters, extra weapons, extra tools, extra resources, access to a level of play, access to multi-player mode, game “skins” or game “mods” (e.g., Minecraft mods, etc.). In the embodiment presented in FIG. 6, the online game services with which the granted compliance incentive rewards are associated are provided by a 3^{rd} party online game service server 306. In other embodiments, scan-triggered healthcare instruction and reminder service server 200 (or an associated server) could provide the associated online game service. In step 1 of this exemplary embodiment, server 200 is adapted to communicate with the hosting 3^{rd} party online game server 306 and to provide the online game server with information associated with online game asset credits that have been granted to user 100. In step 2, online game server 306 receives, processes and applies the associated online game asset credit to an online game service account associated with user 100. In step 3, user 100 may access the online game service server 306 and redeem the associated online game asset credit. It will be appreciated that in other embodiments, users may not be required to have an online game service account in order to redeem an online game asset credit.

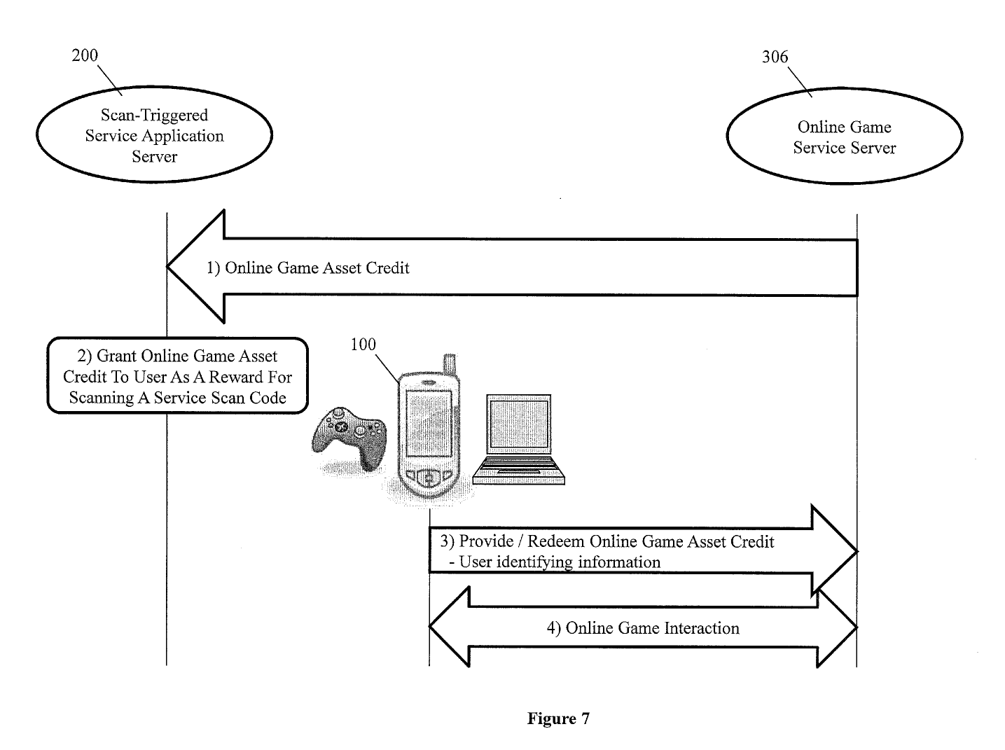

Shown in step 1 of FIG. 7 is an exemplary embodiment, wherein the online game server 306 is adapted to provide scan-triggered healthcare instruction and reminder service server 200 with an online game asset credit, which server 200 may distribute to users of its service as a form of compliance incentive. In step 2, modules 210, 218 and/or 222 associated with server 200 are adapted to distribute to user 100 the online game asset credit previously provided by or obtained from server 306. In step 3, user 100 communicates with server 306 (via any number of possible communication devices, or PCs, gaming consoles, etc.) to provide and thereby redeem the associated online game asset credit, and (in step 4) access the associated services of game server 306. It will be appreciated that credits associated with other online entertainment services (e.g., streaming video, stream music, music download, etc.) may be provided in a manner generally analogous to the above described online game credits/services.

Exemplary OTC Medication Dosing Healthcare Instruction Embodiment

Presented in Table 12-14 is exemplary provisioning data associated with an exemplary embodiment of the present subject matter related to patient medication and medication dosing schedules. In this exemplary embodiment, additional user information may be provisioned by or on behalf of a user of the healthcare instruction and reminder service, including that shown in Table 12. Table 12 includes, user identifier information 476, user family member profile identifier information 486 (e.g., child, spouse, etc.), age information 488, gender information 490, weight or other biometric information 492, previous/existing medical condition information 494 and medication allergy information 496. As such, a user (e.g., a parent or guardian), in addition to their own user profile and associated user personal health information, a user may define one or more sub-profiles (e.g., a family member, child, son, daughter, etc.). The scanning user may then choose to associate a scan of a healthcare instruction service scan code with any provisioned user profile (and the user may provision a new sub-profile at the time of a scan, if necessary). In this way, a parent or guardian may use their smartphone or other mobile scan device to access/obtain healthcare instruction services for not only themselves, but for their dependent users as well. In one embodiment, selection or designation of a particular dependent user profile to which a scan is to be associated may occur immediately post-scan. It will be appreciated that such “dependent” user access (i.e., the ability to define dependent sub-profiles and to designate a particular user profile/sub-profile post scan) capability can be applied to all embodiments described in this disclosure.

Tables 13 and 14 illustrate exemplary provisioning data associated with over the counter (OTC) medication embodiments of the present subject matter. In this embodiment, a HealthcareSquareID value 436 is associated with an medication dosing instruction set 497 related to an OTC medication or healthcare product (e.g., over the counter pain reliever), which is identified via a medication product identifier 498. In one embodiment, identifier 498 may include sufficient information to identify a particular manufacturing lot or batch of the associated product. Associated with the medication product is medication product description information 500, product sales/marketing information web page link information 502, related or co-marketed product information 504, product recall and/or expiration information 506. Also associated with the medication product (as shown in Table 14) is medication dosing criteria and associated rules or guidelines. It will be appreciated that multiple medication dosing criteria rules may be associated with the same dosing instruction set or template. Table 14 includes a medication product identifier 498, patient age criteria 508, patient weight criteria 510, associated dosing rule 512 and associated known medication interaction concerns/criteria, which may impact dosing of the associated medication product. It will be appreciated that these dosing criteria and rules are merely intended to be illustrative of the concept and, in practice, such provisioning data may include considerably more complex dosing criteria and associated dosing rules.

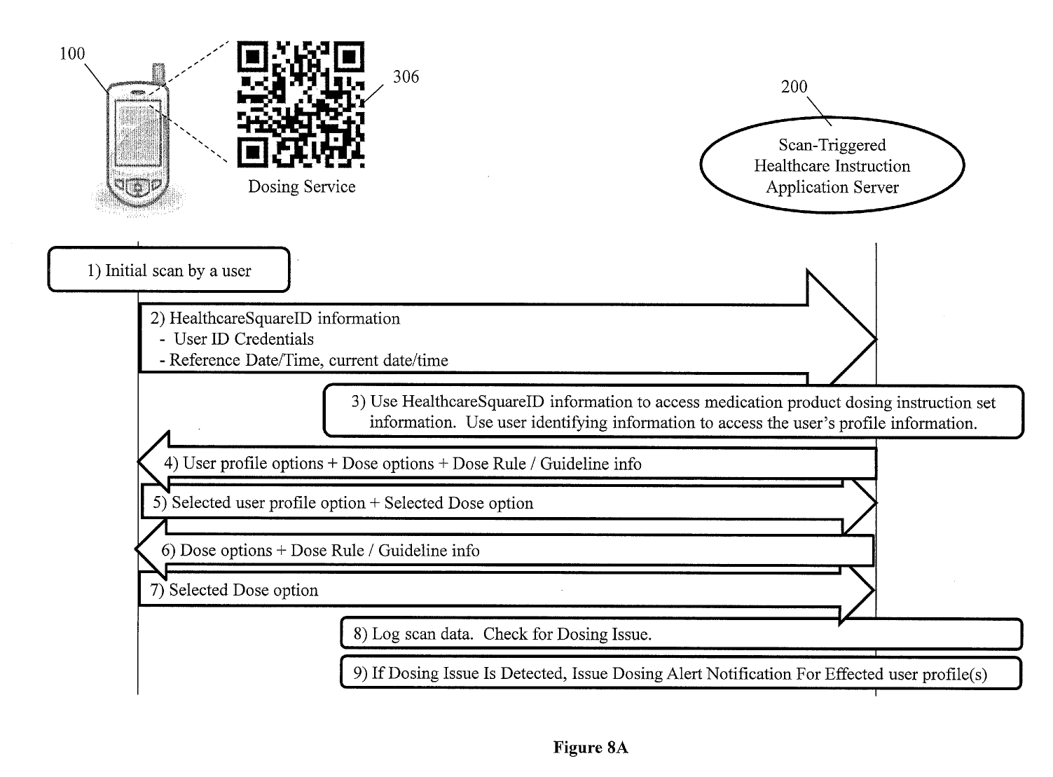

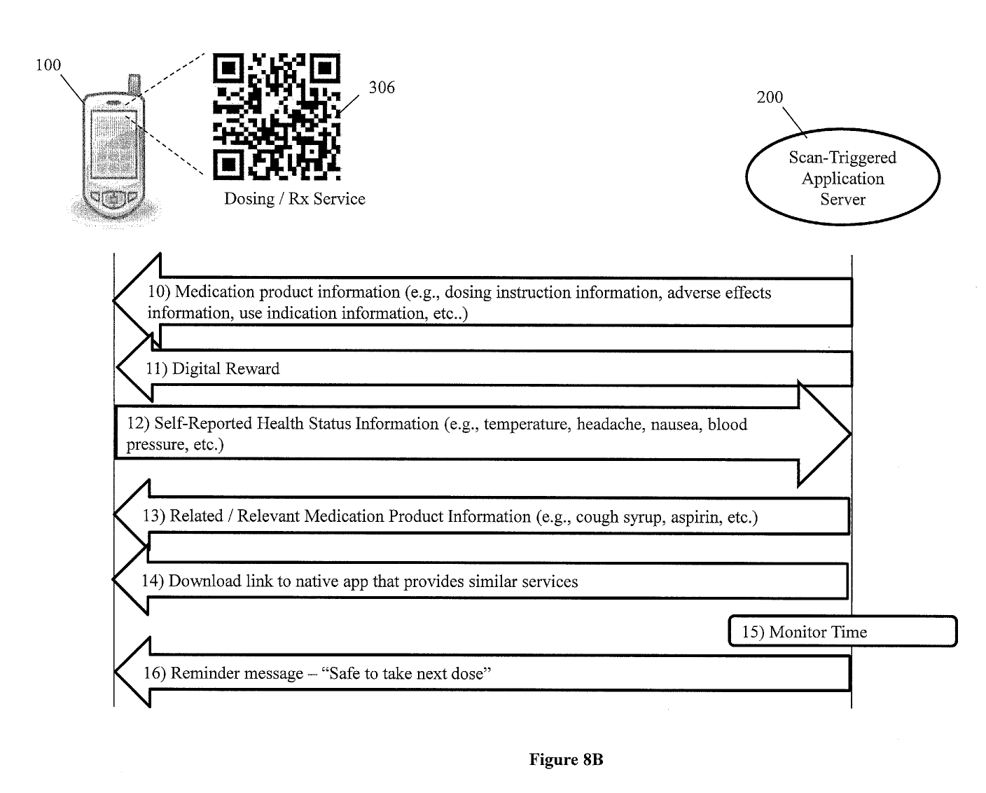

Shown in FIGS. 8A and 8B is another exemplary embodiment of the present healthcare instruction and reminder service of the present subject matter, which is associated with a healthcare instruction set or template that includes patient medication and dosing instructions. This embodiment, described previously as a Dosing Square embodiment, is particularly relevant to over the counter (OTC) medications. In the same general manner as described in the above embodiments, user 100 makes an initial scan of healthcare instruction and reminder service code 306, which has been associated with the exemplary provisioning data described above in Tables 14 and 15. As described previously, the encoded HealthSquareID value is extracted and provided to server 200, along with user identifying information and reference date/time information (step 2). As with all of the embodiments discussed in this disclosure, it will be appreciated that the HealthcareSquareID, userID, reference date/time, and current date/time information referred to above may be provided at different times and/or in different communications between the mobile device 100 and the application server 200.

Also, as with at least some of the embodiments discussed in this disclosure, it will be appreciated that upon the initial scan be a new user of the healthcare instruction service, the user may choose to access the service(s) in a mode that does not require an explicit registration. In such anonymous use scenarios, server 200 may generate and assign a service user identifier (e.g., random/pseudo-random string of characters, numeric identifier, etc.) to the new user for use is accessing/obtaining healthcare instruction services. If the user does not desire to receive externally communicated (e.g., email, text message, Twitter, etc.) instruction reminders or electronic calendar event invitations, it is possible for the user to be assigned a healthcare instruction service identifier that does not include or provide any personally identifying information associated with the user. Such a system-generated healthcare instruction service identifier may be communicated to user 100 and stored, for example, in a cookie on their mobile device. As long as user 100 continues to scan and access the associated healthcare instruction service(s) using that same mobile device (i.e., the mobile device where the cookie resides), the user may access and obtain at least some of the associated healthcare instruction services. Once again, this anonymous user access technique may be applied to all embodiments of the healthcare instruction and reminder service disclosed herein. Such embodiments are advantageous in that they allow user who do not want to provide/share any personal information to access the scan-triggered healthcare instruction services disclosed herein. In most of the exemplary embodiment information flow diagrams presented herein, including FIG. 8A, it is assumed that the scanning user has previously registered with the scan-triggered healthcare instruction and reminder service, and has created or been assigned a unique user identifier that can be used by server 200 to provide the associated healthcare instruction services. User could register via a scan-based or other user provisioning interface (not shown) prior to accessing the associated healthcare instruction service(s).

In one embodiment, reference date/time information may be manually input/specified by user 100 or may be implicitly assumed/determined by server 200 to be the current date and time associated with receipt of the scan information at server 200. In this embodiment, the reference date/time may be associated with the first or most recent dose taken of the medication. In step 3, the received HealthcareSquareID information is used by module 208 of server 200 to locate and access an associated healthcare instruction set or template. In this example, the healthcare instruction set or template includes OTC medication dosing instructions, such as those illustrated in Tables 13 and 14. In one embodiment, additional information necessary to resolve or evaluate a medication dosing rule may be solicited/collected from the scanning user 100. For example, if user 100 has not previously provisioned age and weight information (e.g., the user profile-specific age and weight information illustrated in Table 12), then server 200 may request that user 100 provide such information (steps 4-5). It will be appreciated, as indicated in step 4, that if user 100 has provisioned multiple user profiles (e.g., self, son, daughter, family member, etc.), server 200 may request that the scanning user designate the user profile that is to be associated with the scan and subsequent transaction. The user may, at this point, add/delete/modify user profiles via a provisioning transaction with server 200 (not shown).

Using such information, along with reference date/time information, recommended medication dose and dose schedule option(s) are determined or resolved for the scanning user (or a designated user profile associated with the user). In step 6, the resolved medication dose/dose schedule information is determined by module 208 and provided to user 100 (step 6). In one embodiment, multiple medication dose/dose schedule options are communicated to user 100, who may then select one. Different medication dose options may include, for example, different dosage amounts, different dose point schedules or time intervals, different maximum cumulative dosage amounts in a given time interval, etc. The dose/dose schedule option selection is communicated to server 200, where it is stored in a binding record associated with user 100. It will be appreciated that in one embodiment, the reference date/time is the date/time associated with the initial or most recent dose of the medication. As such, in one embodiment server 200 may implicitly determine/interpret the date/time of the receipt of scan information resulting from the scanning of code 306 by user 100 to be the reference date/time. This may be accomplished via timestamping of the received scan information by server 200 at the time of receipt, or may be accomplished by extracting date/time information from one or more messages communicated between mobile user device 100 and server 200. In one embodiment, module 208 may generate and transmit electronic calendaring event invitations to user 100, where the events are associated with safe or recommended dosage administration points that were resolved for the user (or a user-profile designated by the user). Such electronic calendaring reminder event creation and communication was discussed and described previously in this disclosure, and is not repeated here.

In step 8, the received scan information is logged and a user-specific binding record is created and stored by module 208, which may include information similar to that shown in Table 15. Table 15 includes user identifier information 476, user profile identifier information 516, scanned HealthcareSquareID identifier information 518, dose taken or administered information 520, scan date/timestamp information 522, and granted incentive reward identifier information 524. In step 9, module 208 is adapted to examine available medication interaction issue information (e.g., Table 14, field 514, 3^{rd} party drug interactions database, etc.), as well as logged records associated with concurrent medication use by scanning user 100 and to communicate an alert or warning notification to the scanning user that warns of a potential drug interaction issue (step 9). In one embodiment, module 208 is adapted to examine provisioned known medication/drug allergy information associated with scanning user 100 (or a user-profile designated by the scanning user) to determine if a potential drug/medication allergy issues exists. If a potential drug/medication allergy issue exists, a warning or alert notification may be communicated to the scanning user (step 9). Module 208 is adapted to communicate detailed medication product information and general usage instructions/guideline information, which may include web url/hyperlinks associated with the medication product (step 10). In step 11, a compliance incentive reward may be granted to scanning user 100, as a reward for engaging the healthcare instruction and reminder service. In one embodiment, user 100 may communicate self-reported health status information (e.g., body temperature, fever, headache, blood pressure, etc.) to module 208, where it is logged and stored in a binding record associated with the user (step 12). Such logged health status information may be reported or made available to the user or a healthcare provider. In step 13, co-marketed or related medication product information is communicated to user 100. In step 14, a link that facilitates or initiates the downloading of a native application, which provides similar healthcare instruction and reminder service functionality is communicated to the scanning user. In steps 15 and 16, module 208 is adapted to monitor the passage of time and to generate reminder messages (e.g., email, text message, social media message post, in-app reminder, etc.) regarding an upcoming medication dose point (e.g., the next time it is safe to take another dose of the medication).

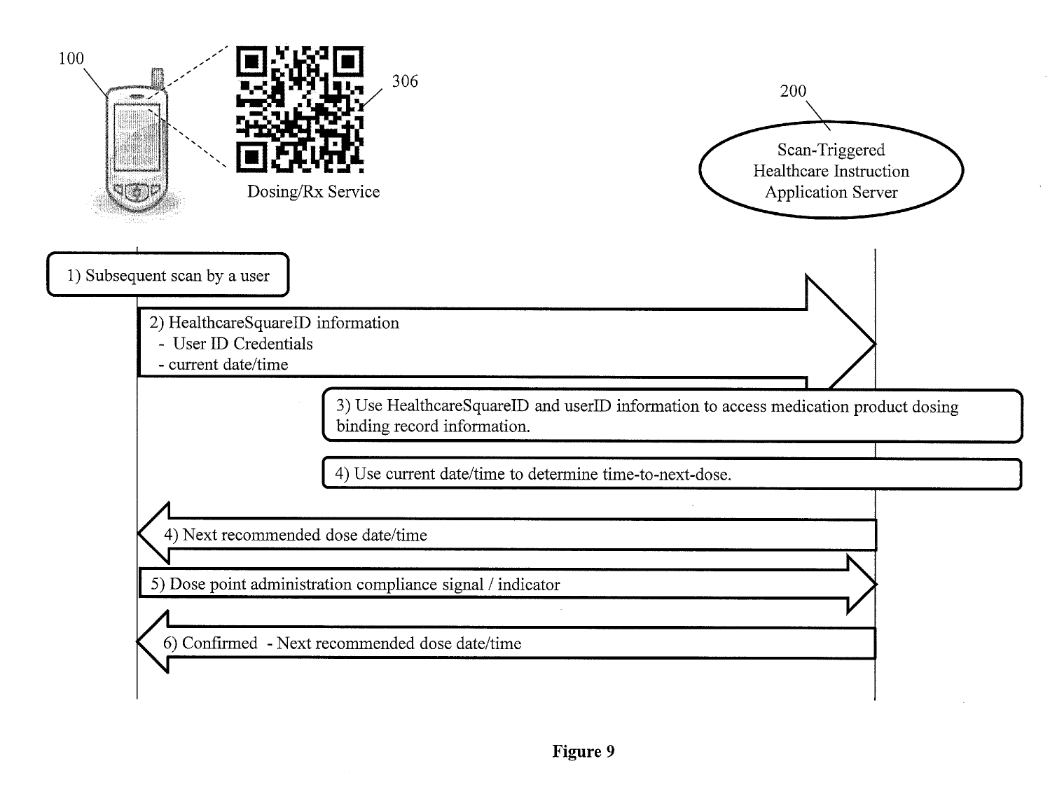

Presented in FIG. 9 is exemplary information flow and processing associated with a subsequent scan of healthcare instruction service code 306 by user 100, following the initial scan of the same code (step 1). In step 2, the HealthcareSquareID is extracted from code 306 and provided to server 200 along with userID information (e.g., user name, mobile device identifier, etc.). Current local time may also be communicated to server 200 or server 200 may obtain the current time from an alternate source. In step 3, the received HealthcareSquareID and userID information is used to located and access the previously created service binding record for the user. In step 4, the current date/time information is used, in conjunction with the user's binding record information, to resolve/compute the next recommended dose point and/or dosage point parameters (e.g., dosage amount, dose point date/time, etc.). Server 200 communicates the next recommended dose point and/or associated dosage point parameters to user 100. In step 5, user 100 signals server 200 that the dose was taken (e.g., by tapping on onscreen button associated with that dose point). The user may also signal dose point parameters (e.g., dosage amount, etc.) to server 200, where it is received and recorded in the user's binding record. In step 6, server 200 acknowledges the user's signal that the dose has been administered, and communicates next recommended dose point and dose point parameters to the user. As described above, dose point reminders may be communicated to user 100 (e.g., via email, text message, social media post, Twitter, etc.) and electronic calendar reminder event invitations may also be generated and transmitted to user 100.

It will be appreciated that other embodiments of the present subject matter may allow a user to specify a reference date/time, which is associated with a preferred medication schedule option or medication schedule start date/time. Exemplary provisioning data associated with such an embodiment is shown in Tables 17-19. Table 17 illustrates exemplary medication product and associated information, including HealthcareSquareID identifier information 436, a client identifier 528, a medication product or drug identifier 530, a prescription identifier 532, product description information 534, retail location identifier information 536, and geographic/distribution region information 538. Table 18 illustrates exemplary medication product dosing instruction information that involves the use of multiple dosage instruction scheduling tuple options that a user may choose from. For example, the user may provide a reference time of 6 am, which would be associated with selection of dosage schedule tuple option 001. Table 18 includes an instruction set identifier 539, a dosage schedule tuple option identifier 540, dosage schedule tuple option description information 542, total or maximum doses to be administered 544. Table 18 illustrates exemplary medication product dosing instruction information that involves the use of multiple dosage instruction scheduling rule options that a user may choose from. For example, the user may provide a reference time of 6 am, which would be associated with selection of an allowed start time of 6 am. Table 19 includes an instruction set identifier 539, dosage schedule rule option identifier information 546, dosage schedule rule option description information 548, medication schedule allowed start time options 550, and total or maximum doses to be administered 552. Such exemplary embodiments are described as RxSquare service in previous disclosures and which are incorporated herein by reference.

Exemplary Skin Care Healthcare Instruction Embodiment

Presented in Table 20-22 is exemplary provisioning data associated with an exemplary embodiment of the present subject matter related to patient skin care protection schedules. As with previous embodiments described herein, a user such as a parent, may create and administer multiple user profiles. As such, a user (e.g., a parent or guardian), in addition to their own “self” user profile and associated user personal health information, a user may define one or more sub-profiles (e.g., a family member, child, son, daughter, etc.). The scanning user may then choose to associate a scan of a healthcare instruction service scan code with any provisioned user profile (and the user may provision a new sub-profile at the time of a scan, if necessary). In this way, a parent or guardian may use their smartphone or other mobile scan device to access/obtain healthcare instruction services for not only themselves, but for their dependent users as well. In one embodiment, selection or designation of a particular dependent user profile to which a scan is to be associated may occur immediately post-scan.

Table 20 service provisioning data includes a HealthcareSquareID identifier 436, a sunscreen product manufacturer identifier 554, a sunscreen product identifier 556 (e.g., UPC, GTIN, etc.), a manufacturing batch or lot identifier 558, expiration date information 559, product description information 560, retailer identifier information 562, and geographic/distribution region identifier information 564. Table 21 skin care sunscreen application/re-application instruction set information with a HealthcareSquare service code. In this example, multiple skin care instruction sets are defined, where each sunscreen re-application instruction set is associated with a different ambient ultraviolet (UV) index value. Table 21 includes a HealthcareSquareID identifier 436, an ambient UV index value 566, a sunscreen re-application instruction set identifier 568 and a compliance incentive reward identifier 570. Table 22 illustrates sunscreen product re-application frequency instructions, which include instruction set identifier information 568, sunscreen re-application frequency (if the wearer is in water or exercising heavily/sweating) 572 and sunscreen re-application frequency (in a dry environment/use setting) 574.

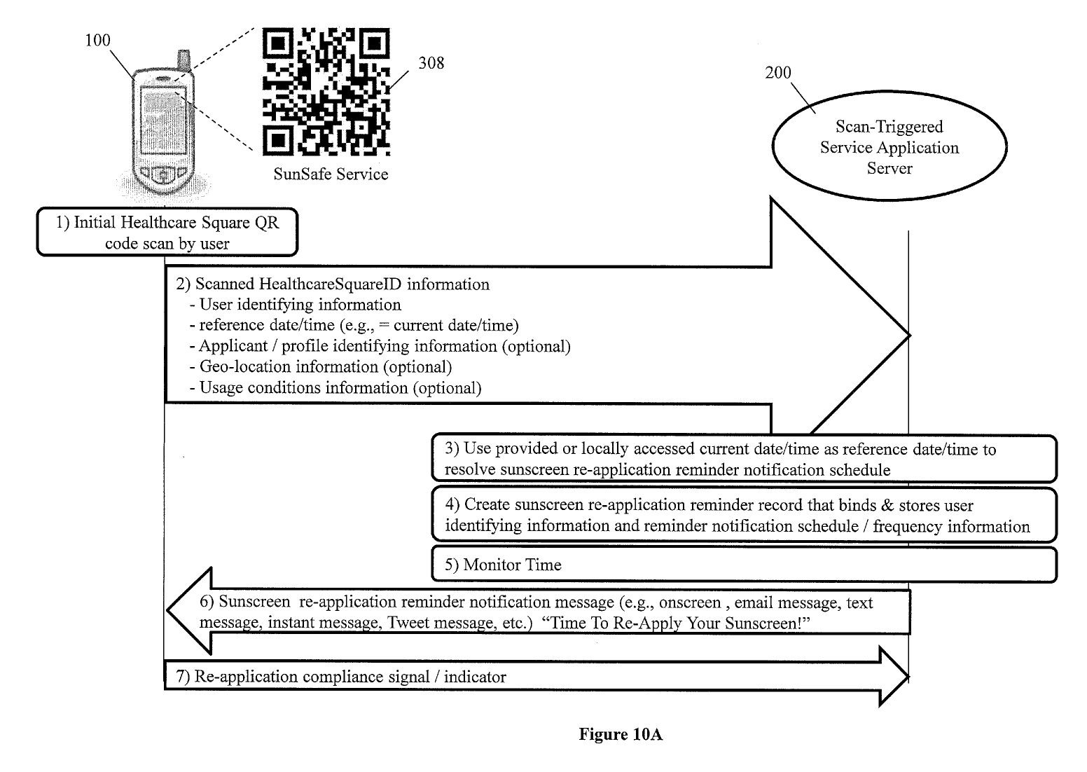

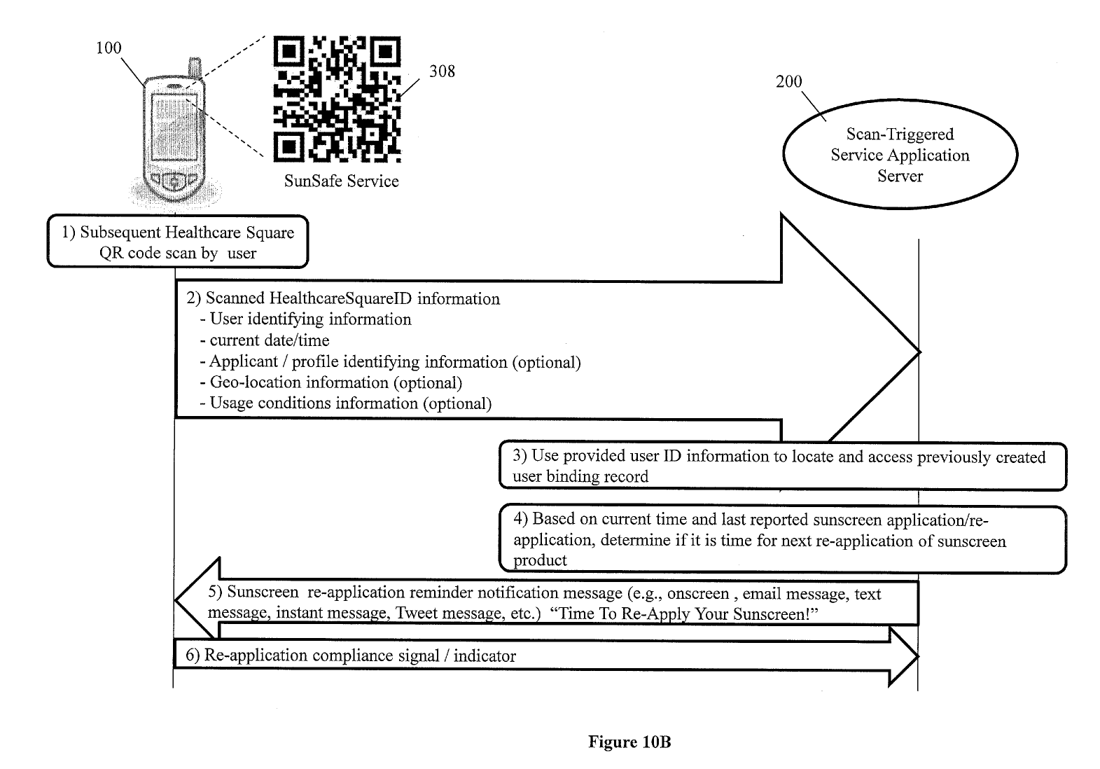

Presented in FIG. 10A is an exemplary information and process flow diagram associated with an embodiment of the present scan-triggered healthcare instruction and reminder service that relates to a dermatological OTC sunscreen product. In this example, the provisioned sunscreen healthcare instruction information in Tables 20-22, described above, is associated with healthcare instruction service scan code 308. Embodiments of this service have been described in previous disclosures as SunSafe Square service. In step 1, user 100 makes an initial scan of healthcare instruction and reminder service code 308, which has been associated with the exemplary provisioning data described above in Tables 20-22. In a manner similar to that previously described, the encoded HealthSquareID value is extracted and provided to server 200, along with user identifying information and reference date/time information (step 2). As with all of the embodiments discussed in this disclosure, it will be appreciated that the HealthcareSquareID, userID, reference date/time, and current date/time information referred to above may be provided at different times and/or in different communications between the mobile device 100 and the application server 200. In one embodiment, the reference date/time is assumed by server 200 to be the current date/time at the time of the scan. In one embodiment, the reference date/time is associated with initial application of the sunscreen product. In other embodiments, reference date/time information may be collected at each scan of code 308 and used to mark the application or re-application of the sunscreen product. It will also be appreciated that if no user identifier is provided, server 200 may generate and assign a user identifier to user 100 and it may be stored in a cookie on the user's mobile device. Such dynamic user identifier creation is described in more detail elsewhere in this disclosure with respect to an anonymous mode of user interaction/operation. Additional information may be provided at the time of the scan or in subsequent communications with server 200, such as designated user profile information (e.g., self, Timmy, son, daughter, etc.), geo-location information and usage conditions (e.g., heavy exercise, swimming, dry, etc.). In step 3, the received HealthcareSquareID information is used by module 208 of server 200 to locate and access the appropriate healthcare instruction set or template. The reference date/time information is used to resolve the sunscreen product re-application schedule for the associated sunscreen product based on the provisioned re-application frequency rules/guidelines. In one embodiment, user profile information, geo-location information, and usage condition information may be used to during the re-application schedule resolution process to adjust or augment the re-application schedule for a particular user or user profile. For example, using geo-location information (e.g., GPS coordinates provided by the user's mobile device) or approximate geo-location information obtained by analyzing the source Internet protocol (IP) address (e.g., consulting an external database that maps source IP addresses to approximate geo-locations or geographic regions), module 208 is able to obtain current or expected UV index values for the user's current geo-location. Such UV index information may be used by module 208 during the resolution or evaluation of sunscreen re-application intervals/schedules for the user. Usage conditions/setting information (e.g., in-water, dry, etc.) may be used in a similar manner by module 208 during the resolution or evaluation of sunscreen re-application intervals/schedules for the user.

In step 4, the user's resolved sunscreen re-application schedule instructions and associated instruction step reminders (e.g., reminders to re-apply sunscreen) are stored along with user identifier information in a binding record at server 200. Exemplary user binding record information is shown in Table 23, and includes a scan transaction identifier 576, the associated/received HealthcareSquareID identifier 578, the associated user identifier 580, the associated user profile identifier 582, the usage environment/UV index 584, user geo-location information 586, the user's next same-product re-application time 587 and scan timestamp information 588. In steps 5 and 6, server 200 is adapted to monitor the passage of time and to generate, based on the user's resolved re-application schedule, one or more sunscreen product re-application reminder notification messages (e.g., email, text, social media message post, Twitter, etc.) that are communicated to the user 100 in a manner similar to that described previously. The re-application reminder messages may include, but is not limited to, sunscreen re-application parameter information, such as a recommended sunscreen product, a recommended sun protection factor (SPF), the date/time that the sunscreen product should be re-applied, etc. In step 7, user 100 signals server 200 that sunscreen has been re-applied, and module 208 updates the user's binding record to record the user's re-application of sunscreen product. In one embodiment, module 208 may utilize current date/time information associated with the scan to check provisioned product expiration information in order to determine whether the sunscreen product has expired or is near the expiration date. A product expiration notification message may be presented to the user onscreen at the time of the scan or an external notification message may be generated and communicated to the user (e.g., via email, text message, social media message post, Twitter, etc.).

Presented in FIG. 10B is an exemplary information and process flow associated with a subsequent scan of the same healthcare instruction service scan code 308 by user 100. In step 1, the user 100 makes a subsequent scan of healthcare instruction and reminder service code 308. As in the previous example, the encoded HealthcareSquareID is extracted and communicated to server 200 along with user identifier information, current date/time information, designated user profile identifier information, geo-location information and usage condition information (step 2). In step 3, the received HealthcareSquareID and userID information is used to locate and access the user's previously created service binding record. Based on the current date/time (e.g., the date/time of the user's scan), module 208 uses the information stored in the user's service binding record and/or instruction set information associated with the provided HealthcareSquareID to determine whether a sunscreen re-application is appropriate at the current time and/or when the next sunscreen re-application is scheduled (step 4). Server 200 communicates a sunscreen re-application notification message to the scanning user 100, which notifies them of that it is time to re-apply sunscreen, or how long until the next re-application, or when the next re-application time will be (step 5). Information that identifies a particular sunscreen product or SPF protection level associated with the re-application instruction step event may also be communicated to the user 100. In step 6, the user 100 signals server 200 that sunscreen re-application instruction has been completed/complied with.

In one embodiment, modules 210, 218 and or 222, may grant a reward, such as a digital coupon for a sunscreen product or other reward types previously described herein. In one embodiment, a reward such as an online game, online video or online music credit may be granted to a user as a sunscreen re-application compliance reward, in a manner similar to that described with respect to other embodiments of the healthcare instruction and reminder service disclosed herein.

It will be appreciated that in one embodiment, sunscreen re-application healthcare instruction scan codes, such as code 308, may be printed or displayed on a package of sunscreen product so as to be easily accessible to users. By using the present invention, it is possible to print the same healthcare instruction and reminder service scan code on each package of sunscreen, and still allow all scanning users of this code to obtain individualized service.

Exemplary Wound Management Healthcare Instruction Embodiment

Presented in Tables 24-27 is exemplary provisioning data associated with an exemplary embodiment of the present subject matter related to patient wound management schedules. As with previous embodiments described herein, a user such as a parent or healthcare provider, may create and administer multiple user profiles. As such, a user (e.g., a parent or guardian), in addition to their own “self” user profile and associated user personal health information, a user may define one or more sub-profiles (e.g., a family member, child, son, daughter, patient, etc.). The scanning user may then choose to associate a scan of a healthcare instruction service scan code with any provisioned user profile (and the user may provision a new sub-profile at the time of a scan, if necessary). In this way, a parent or guardian may use their smartphone or other mobile scan device to access/obtain healthcare instruction services for not only themselves, but for their dependent users as well. In one embodiment, selection or designation of a particular dependent user profile to which a scan is to be associated may occur immediately post-scan.

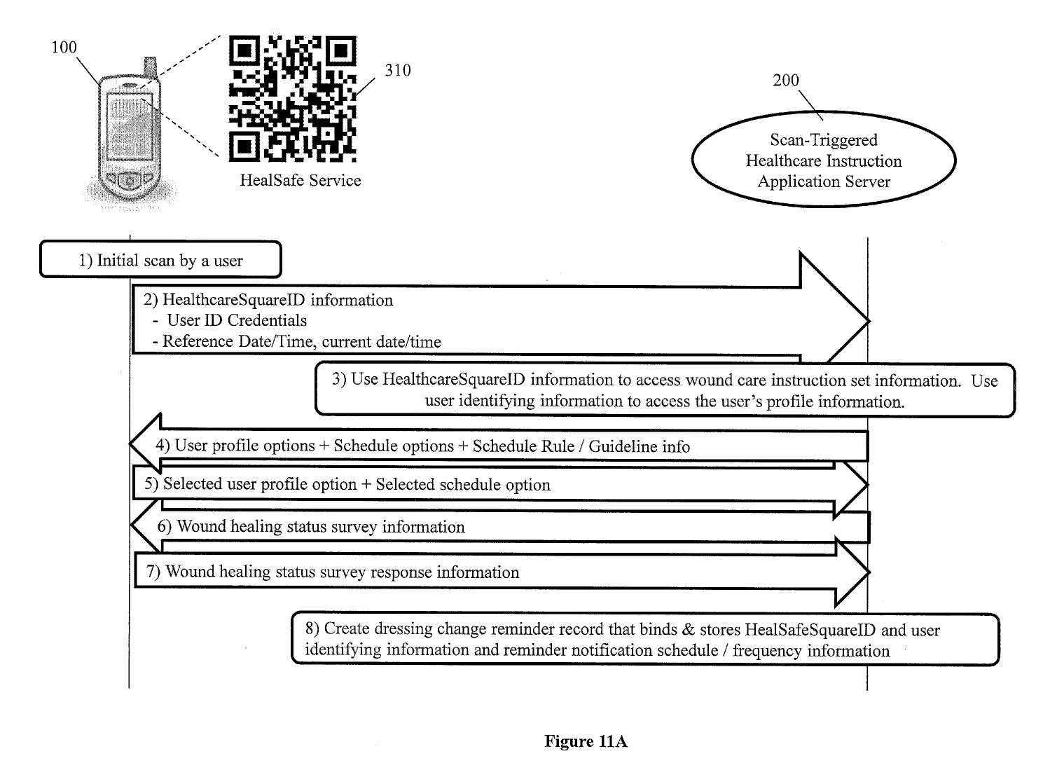

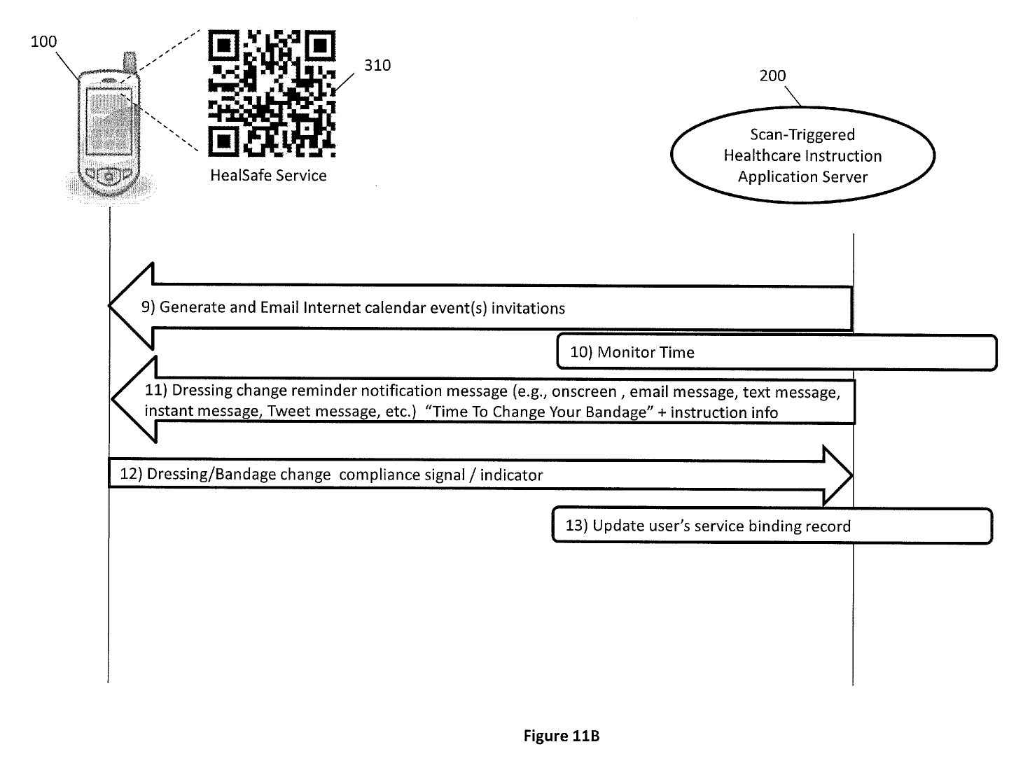

In one embodiment of the present subject matter, a healthcare instruction and reminder service scan code, such as code 310, shown in FIG. 11A, may be printed on or otherwise associated with a bandage or other wound dressing materials. Such bandages and wound dressing materials may be retail consumer bandage products or hospital-grade products. Table 24 service provisioning data includes a HealthcareSquareID identifier 436, a wound care product manufacturer identifier 590, product identifier 592 (e.g., UPC, GTIN, etc.), product description information 594 (e.g., text, web link, URL, video link, etc.), retail location identifier 596, retail or distribution region identifier 598.

Table 25 illustrates exemplary wound management/bandage product change or replacement instruction info nation that involves the use of multiple bandage change instruction scheduling tuple options that a user may choose from. For example, the user may provide a reference time of 6 am, which would be associated with selection of bandage change schedule tuple option 001. Table 25 includes a HealthcareSquareID identifier 436, an instruction set identifier 599, a bandage or dressing change schedule tuple option identifier 600, bandage or dressing change schedule tuple option description information 602, total or maximum bandage changes to be performed 604. Table 26 illustrates exemplary bandage or dressing change instruction information that involves the use of multiple bandage or dressing change instruction scheduling rule options that a user may choose from. For example, the user may provide a reference time of 6 am, which would be associated with selection of an allowed start time of 6 am. Table 26 includes a HealthcareSquareID identifier 436, an instruction set identifier 599, bandage or dressing change schedule rule option identifier information 606, bandage or dressing change schedule rule option description information 608, bandage or dressing change schedule allowed start time options 610, and total or maximum bandage or dressing changes to be performed 612. Such exemplary embodiments are described as HealSafe Square service in previous disclosures and which are incorporated herein by reference. Table 27 illustrates exemplary wound healing status/user health status survey information, which includes HealthcareSquareID identifier 436, InstructionSetID identifier 599, wound healing status/health status survey identifier information 614, wound healing status/health status survey question 616, and wound healing status/health status survey response options 618.

Presented in FIGS. 11A and 11B is an exemplary information and process flow diagram associated with an embodiment of the present scan-triggered healthcare instruction and reminder service that relates to a wound management healthcare product. In this example, the provisioned wound management schedule healthcare instruction information in Tables 24-26, described above, is associated with healthcare instruction service scan code 310. Embodiments of this service have been described in previous disclosures as HealSafe Square service. In step 1, user 100 makes an initial scan of healthcare instruction and reminder service code 310, which has been associated with the exemplary provisioning data described above in Tables 24-26. In a manner similar to that previously described, the encoded HealthSquareID value is extracted and provided to server 200, along with user identifying information and reference date/time information (step 2). As with all of the embodiments discussed in this disclosure, it will be appreciated that the HealthcareSquareID, userID, reference date/time, and current date/time information referred to above may be provided at different times and/or in different communications between the mobile device 100 and the application server 200. In one embodiment, the reference date/time is assumed by server 200 to be the current date/time at the time of the scan. In one embodiment, the reference date/time is associated with the initial application of the dressing/bandage. In one embodiment, the reference date/time is assumed by server 200 to be the current date/time at the time of the scan. In one embodiment, the reference date/time is associated with initial application of the wound dressing/bandage product. In other embodiments, reference date/time information may be collected at each scan of code 310 and used to mark the application or re-application of the wound dressing/bandage product.

It will also be appreciated that if no user identifier is provided, server 200 may generate and assign a user identifier to user 100 and it may be stored in a cookie on the user's mobile device. Such dynamic user identifier creation is described in more detail elsewhere in this disclosure with respect to an anonymous mode of user interaction/operation. Additional information may be provided at the time of the scan or in subsequent communications with server 200, such as designated user profile information (e.g., self, Timmy, son, daughter, etc.) and usage conditions (e.g., heavy exercise, swimming, dry, etc.). In step 3, the received HealthcareSquareID information is used by module 208 of server 200 to locate and access the appropriate healthcare instruction set or template. The reference date/time information is used to resolve the wound management/bandage change schedule based on the provisioned wound dressing/bandage change frequency rules/guidelines. In one embodiment, user profile information and usage condition information may be used to during the wound dressing/bandage change schedule resolution process to adjust or augment the wound dressing/bandage change schedule for a particular user or user profile. Usage conditions/setting information (e.g., in-water, dry, etc.) may be used in a similar manner by module 208 during the resolution or evaluation of wound dressing/bandage change intervals/schedules for the user. In one embodiment (not shown), a default dressing/bandage change schedule may be associated with the scanning user 100. In the more complex embodiment shown in 11A, the scanning user 100 is presented with one or more dressing/bandage schedule change options, as well as user profile designation options (step 4). As with other embodiments of healthcare instruction and reminder service described herein, user 100 may define and/or designate a dependent user profile (e.g., family member, friend, patient, etc.) with which the scan is to be associated. In step 5, user 100 provides dressing/bandage schedule selection and user profile designation selection option information to server 200. In step 6, server 200 may communicate wound healing status or health status survey information to the scanning user, such as that shown in Table 27. In one embodiment, wound healing status or health status survey information is displayed on user 100's mobile device and the user may tap a survey response option button onscreen to signal the response selection to server 200 (step 7). In step 8, module 208 creates and stores a service binding record entry for user 100, which may include resolved dressing/bandage change schedule information, user-specific dressing/bandage change reminder notification information, wound healing status/health survey response information, scan timestamp information and compliance incentive reward grant information. In one embodiment, module 208 may utilize reference date/time information (e.g., dressing/bandage application time point, etc.) associated with the scanning user (or user-profile) along with a default or user-specified healthcare instruction set rule (e.g., bandage change frequency) or schedule (relative date/time offsets associated with bandage change points, e.g., +3 hrs, +4 hrs, +7 hrs, +10 hrs) to resolve and store a specific dressing/bandage change instruction schedule for that user. Such resolved instruction set information is stored in a service binding record associated with the user or designated user profile. Exemplary user binding record information is presented in Tables 28-31.

Table 28 includes a scan transaction identifier 620, a HealthcareSquareID identifier 622, user identifier and/or user profile identifier 624, dressing/bandage change schedule option identifier 626, initial dressing/bandage application 628, scan timestamp information 630. Table 29 includes a scan transaction identifier 620, a HealthcareSquareID identifier 622, user identifier and/or user profile identifier 624, dressing/bandage change rate/frequency option identifier 632, initial dressing/bandage application 636, scan timestamp information 638. Table 30 includes a scan transaction identifier 620, a HealthcareSquareID identifier 640, dressing/bandage change timestamp information 642, health/wound healing status survey identifier information 644, and health/wound healing status survey response information 646. Table 31 includes a scan transaction identifier 620, granted compliance incentive reward 648, reward expiration date information 650, reward redemption date information 652 and reward redemption code information 654 (e.g., digital or bar code provided to the retailer who is redeeming the digital reward/coupon).

As indicated in step 9 of FIG. 11B, once user 100's dressing/bandage change schedule has been resolved using the reference date/time information, server 200 is adapted to generate one or more electronic calendar reminder event invitations associated with some or all of the resolved dressing/bandage change time points, in a manner similar to that described in detail elsewhere in this disclosure. Server 200 then monitors the passage of time (step 10) and determines, based on information contained in the user binding records, when dressing/bandage change notifications are to be generated and sent to the user 100 (step 11). In step 12, user 100 signals server 200 of compliance with the associated dressing/bandage change event. In one embodiment, a hyperlink or click-able URL link may be included in a reminder notification message that is sent to the user in step 11, which causes an associated compliance notification signal to be sent to server 200, where it is recorded in the user's service binding record. In step 13, the user's service binding record is updated to reflect receipt of the instruction step compliance signal. In one embodiment, (which applies to all of the examples presented in this disclosure) the date/time associated with a user's instruction step compliance signal may be interpreted or taken by server 200 as a new reference date/time point, and the associated healthcare instruction set or template may be resolved again (and subsequently stored), using this new reference date/time information.

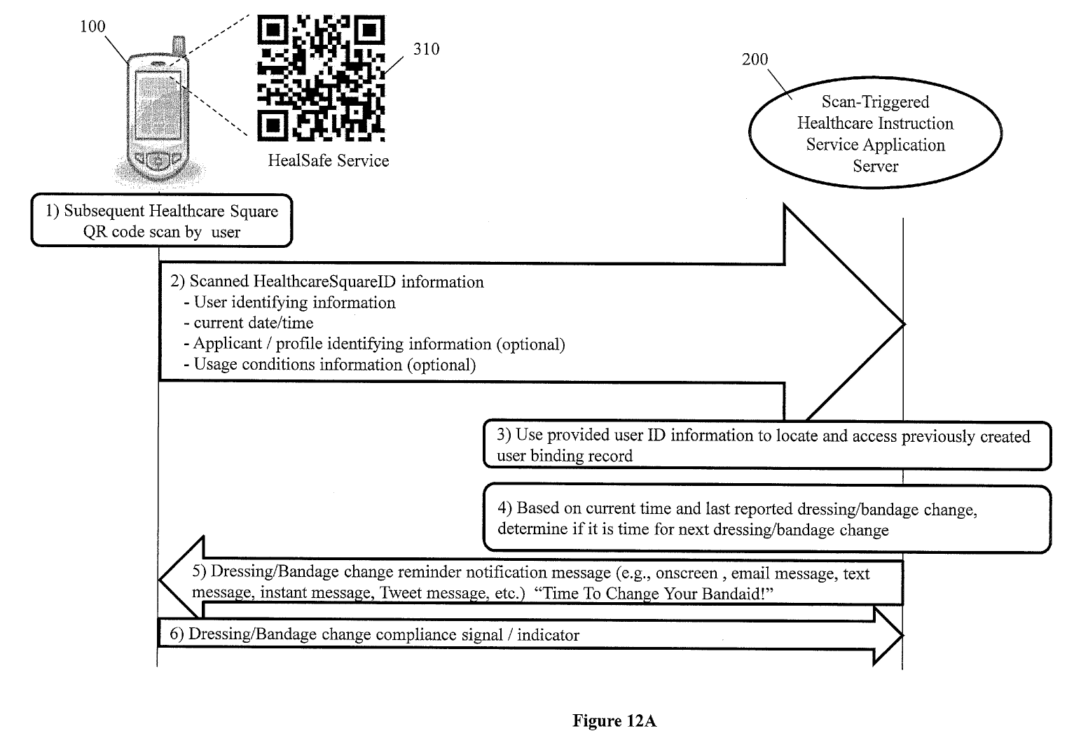

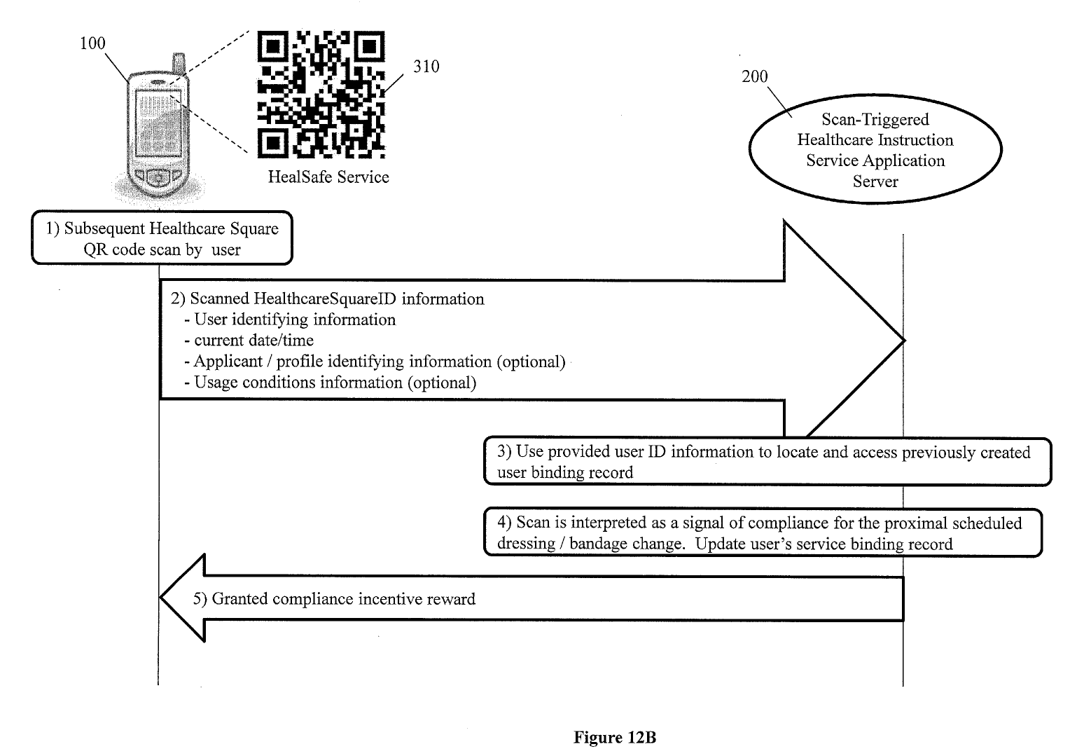

Presented in FIGS. 12A and 12B illustrate an exemplary information and process flow associated with a subsequent scan of the same healthcare instruction service scan code 310 by user 100. In step 1, the user 100 makes a subsequent scan of healthcare instruction and reminder service code 310. As in the previous example, the encoded HealthcareSquareID is extracted and communicated to server 200 along with user identifier information, current date/time information, designated user profile identifier information and usage condition information (step 2). In step 3, the received HealthcareSquareID and userID information is used to locate and access the user's previously created service binding record. Based on the current date/time (e.g., the date/time of the user's scan), module 208 uses the information stored in the user's service binding record and/or instruction set information associated with the provided HealthcareSquareID to determine whether a wound dressing/bandage change is appropriate at the current time and/or when the next dressing/bandage change is scheduled (step 4). Server 200 communicates a dressing/bandage change notification message to the scanning user 100, which notifies them of that it is time to change their bandage, or how long until the next bandage change, or when the next bandage change time will be (step 5). Information that identifies a particular wound dressing or bandage product associated with the dressing/bandage change instruction step event may also be communicated to the user 100. In step 6, the user 100 signals server 200 that the dressing/bandage change instruction has been completed/complied with. In one embodiment of the present subject matter,

In one embodiment, modules 210, 218 and or 222, may grant a reward, such as a digital coupon for a wound dressing or bandage product or other reward types previously described herein. In one embodiment, a reward such as an online game, online video or online music credit may be granted to a user as a dressing/bandage change/wound care compliance reward, in a manner similar to that described with respect to other embodiments of the healthcare instruction and reminder service disclosed herein.

Presented in 12B is an exemplary information and process flow associated with a subsequent scan of the same healthcare instruction service scan code 310 by user 100. In this embodiment, the user's scan is interpreted by server 200 as a signal of instruction step completion or compliance. In one embodiment, server 200 interprets the scan as a compliance signal that is associated with a proximal instruction step. For example, if the user scan of code 310 is received within a 10 minute window around a scheduled dressing/bandage change instruction step for the user (for an associated user profile), then module 208 is adapted to interpret the scan as a signal of completion or compliance of the proximal instruction step. In various embodiments, server 200 may request confirmation from the scanning user of the associated healthcare instruction step with which the scan is to be associated with (i.e., to request that the user confirm that they are intending to signal compliance for a particular instruction step/bandage change step, etc.). Server 200 may also request confirmation from the scanning user with regard to which user profile the compliance confirmation scan is to be associated, as necessary/required. In one embodiment, a scan-to-signal-compliance allowed time window (e.g., 10 minutes before or after, 10 minutes before and 20 minutes after, etc.) may be defined and enforced by server 200, which determines the size of the time window around an instruction step event during which a scan should be interpreted as a signal of compliance. It will be appreciated that this same scan-to-signal-compliance mechanism can be applied to all of exemplary embodiments disclosed and described herein. In one embodiment, a designated compliance guardian may be notified if compliance with an associated healthcare bandage change instruction step is not signaled within a specified time limit, as described in detail elsewhere in this disclosure.

In step 1, user 100 makes a subsequent scan of healthcare instruction and reminder service code 310, which is intended to be a signal of compliance with a proximal bandage change instruction step/scheduled bandage change event. As in the previous example, the encoded HealthcareSquareID is extracted and communicated to server 200 along with user identifier information, current date/time information and (optionally) designated user profile identifier information (step 2). In step 3, the received HealthcareSquareID and userID information is used to locate and access the user's previously created service binding record. Based on the current date/time (e.g., the date/time of the user's scan), module 208 determines if there is a proximal bandage change instruction step for which a compliance signal/indication has not yet been received. If such a proximal instruction step exists (and it is within a predefined time window, e.g., 10 minutes before and 20 minutes after), then module 208 is adapted to interpret the scan as a signal of compliance for the proximal bandage change instruction step and update the user's service binding record accordingly (step 4). In step 5, a compliance incentive reward is granted to the scanning user (or a designated user-profile). It will be appreciated that if multiple user profiles are currently active at the time of the scan, server 200 may request that the scanning user 100 specify for which user profile the compliance signal is intended.

It will be appreciated that in one embodiment, wound dressing/bandage change healthcare instruction scan codes, such as code 310, may be printed or displayed on the packaging of a wound dressing or bandage product, or on the wound dressing or bandage product itself, so as to be easily accessible to users. By using the present invention, it is possible to print the same healthcare instruction and reminder service scan code on each package of wound dressing/bandage product or on the products themselves, and still allow all scanning users of this code to obtain individualized service.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

1. A system for providing scan-triggered healthcare instruction and reminder services, the system comprising:
a computing platform including at least one processor:
a server application module executable by or embodied within the at least one processor and configured to:
receive a request for healthcare instruction service from a scan-enabled client module, wherein the request includes a healthcare instruction set identifier obtained from the scanning of a scanable healthcare instruction and reminder service code by a user;
determine a reference time associated with the request for the healthcare instruction service;
use the healthcare instruction set identifier to access an associated healthcare instruction set that contains healthcare instruction steps with relative temporal offsets;
use the reference time to resolve the relative temporal offsets included in the healthcare instruction set so as to obtain resolved temporal scheduling values for the healthcare instruction steps; and
communicate the healthcare instruction steps associated with the resolved temporal scheduling values to the user.

2. The system of claim 1 wherein the healthcare instruction and reminder service code includes an encoded network address that is used to route the request to the server application module.

3. The system of claim 1 wherein the server application module is configured to determine the reference time based on information provided by the user.

4. The system of claim 1 wherein the server application module is configured to determine the reference time based on a time of receipt of the request.

5. The system of claim 1 wherein the resolved temporal scheduling values include one of: an amount of time to elapse before a healthcare instruction step is to be performed and a time at which a healthcare instruction step is to be performed.

6. The system of claim 1 wherein the server application module is configured to generate and transmit electronic calendar reminder event invitations associated with the healthcare instruction steps and the resolved temporal scheduling values.

7. The system of claim 1 wherein the server application module is configured to monitor the passage of time and generating and transmitting instruction step reminders associated with the resolved healthcare instruction step temporal values.

8. The system of claim 1 wherein the server application module is configured to generate and store a service binding record associated with the user that includes the reference time.

9. The system of claim 1 wherein the server application module is configured to receive and store a compliance signal associated with at least one of the healthcare instruction steps.

10. The system of claim 9 wherein the compliance signal comprises the healthcare instruction service identifier resulting from a scan of the healthcare instruction and reminder service code by the user.

11. The system of claim 9 wherein the server application module is configured to, in response to receiving the compliance signal, grant a compliance incentive reward to the user.

12. The system of claim 9 wherein the server application module is configured to, in response to failing to receive the compliance signal, generate and transmit a non-compliance alert message.

13. A method for providing scan-triggered healthcare instruction and reminder services, the method comprising:
in a computing platform including at least one processor that executes a server application module:
receiving a request for healthcare instruction service from a scan-enabled client module, wherein the request includes a healthcare instruction set identifier obtained from the scanning of a scanable healthcare instruction and reminder service code by a user;
determining a reference time associated with the request for the healthcare instruction service;
using the healthcare instruction set identifier to access an associated healthcare instruction set that contains healthcare instruction steps with relative temporal offsets;
using the reference time to resolve the relative temporal offsets included in the healthcare instruction set so as to obtain resolved temporal scheduling values for the healthcare instruction steps; and
communicating the healthcare instruction steps associated with resolved temporal scheduling values to the user.

14. The method of claim 13 wherein the healthcare instruction and reminder service code includes an encoded network address that is used to route the request to the server application module.

15. The method of claim 13 wherein the server application module is configured to determine the reference time based on information provided by the user.

16. The method of claim 13 wherein determining the reference time includes determining the reference time based on a time of receipt of the request.

17. The method of claim 13 wherein the resolved temporal scheduling values include one of: an amount of time to elapse before a healthcare instruction step is to be performed and a time at which a healthcare instruction step is to be performed.

18. The method of claim 13 including generating and transmitting electronic calendar reminder event invitations associated with the healthcare instruction steps and the resolved temporal scheduling values.

19. The method of claim 13 including monitoring the passage of time and generating and transmitting instruction step reminders associated with the resolved healthcare instruction step temporal values.

20. The method of claim 13 including generating and storing a service binding record associated with the user that includes the reference time.

21. The method of claim 13 including receiving and storing a compliance signal associated with at least one of the healthcare instruction steps.

22. The method of claim 21 wherein receiving the compliance signal comprises receiving the healthcare instruction service identifier resulting from a scan of the healthcare instruction and reminder service code by the user.

23. The method of claim 21 including, in response to receiving the compliance signal, granting a compliance incentive reward to the user.

24. The method of claim 21 including, in response to failing to receive the compliance signal, generating and transmitting a non-compliance alert message.

25. A non-transitory computer readable medium having stored thereon executable instructions that when executed by the processor of a computer control the computer to perform steps comprising:
receiving a request for healthcare instruction service from a scan-enabled client module, wherein the request includes a healthcare instruction set identifier obtained from the scanning of a scanable healthcare instruction and reminder service code by a user;
determining a reference time associated with the request for the healthcare instruction service;
using the healthcare instruction set identifier to access an associated healthcare instruction set that contains healthcare instruction steps with relative temporal offsets;
using the reference time to resolve the relative temporal offsets included in the healthcare instruction set so as to obtain resolved temporal scheduling values for the healthcare instruction steps; and
communicating the healthcare instruction steps associated with the resolved temporal scheduling values to the user.
